(19) United States
(12) Patent Application Publication
(10) Pub. No.: US 2026/0296007 A1
(43) Pub. Date: Oct. 1, 2026

(54) Head Unit And Liquid Ejecting Apparatus

(71) Applicant: SEIKO EPSON CORPORATION, Tokyo (JP)

(72) Inventor: Tadashi HAYASHI, Matsumoto (JP)

(21) Appl. No.: 19/577,750

(22) Filed: Mar. 25, 2026

(30) Foreign Application Priority Data
Mar. 26, 2025 (JP) 2025-051800

(51) Int. Cl. B41J 2/045; B41J 2/14; B41J 2/155; B41J 29/393

(52) U.S. Cl. CPC B41J 2/04588; B41J 2/0451; B41J 2/04541; B41J 2/04563; B41J 2/04571; B41J 2/04581; B41J 2/14233; B41J 2/155; B41J 29/393

(57) ABSTRACT

A head unit includes a head controller that receives input of a drive control signal and controls a printhead, in which the head controller includes a storage circuit that stores a plurality of pieces of waveform information, a waveform selection circuit that selects one of the plurality of pieces of waveform information as drive waveform information in accordance with one of a plurality of waveform information tables and the drive control signal, a drive signal output circuit that outputs a drive signal corresponding to the drive waveform information, and a detection circuit that detects states of the printhead and the head controller, and the waveform selection circuit selects first drive waveform information in accordance with first drive information and a first waveform information table, and selects second drive waveform information in accordance with the first drive information and a second waveform information table.

The present application is based on, and claims priority from JP Application Serial Number 2025-051800, filed Mar. 26, 2025, the disclosure of which is hereby incorporated by reference herein in its entirety.

### BACKGROUND

### 1. Technical Field

The present disclosure relates to a head unit and a liquid ejecting apparatus.

### 2. Related Art

A liquid ejecting apparatus, such as one according to JP-A-2023-030330, including an ejecting unit (head unit) that includes a liquid ejecting module (printhead) which ejects a liquid to a medium, and a control unit that is attachable to the ejecting unit and controls an operation of the ejecting unit is known as a liquid ejecting apparatus that ejects a liquid to a medium.

In a liquid ejecting apparatus 1 such as one according to JP-A-2023-030330, an issue that arises when the number of head units coupled to the control unit increases is not sufficiently addressed, and there is room for improvement.

### SUMMARY

According to an aspect of the present disclosure, a head unit includes a printhead that ejects a liquid in accordance with a drive signal, and a head controller that receives input of a drive control signal and controls the ejection of the liquid from the printhead, in which the head controller includes a storage circuit that stores a plurality of pieces of waveform information, a waveform selection circuit that selects one of the plurality of pieces of waveform information as drive waveform information in accordance with one of a plurality of waveform information tables and the drive control signal, a drive signal output circuit that outputs the drive signal corresponding to the drive waveform information selected by the waveform selection circuit, and a detection circuit that detects a state of at least one of the printhead or the head controller, and the waveform selection circuit selects first drive waveform information as the drive waveform information in accordance with first drive information as the drive control signal and a first waveform information table among the plurality of waveform information tables, and selects second drive waveform information different from the first drive waveform information as the drive waveform information in accordance with the first drive information and a second waveform information table among the plurality of waveform information tables.

According to another aspect of the present disclosure, a liquid ejecting apparatus includes a head unit including a printhead that ejects a liquid in accordance with a drive signal, and a head controller that receives input of a drive control signal and controls the ejection of the liquid from the printhead, and a control unit that controls the head unit, in which the head controller includes a storage circuit that stores a plurality of pieces of waveform information, a waveform selection circuit that selects one of the plurality of pieces of waveform information as drive waveform information in accordance with one of a plurality of waveform information tables and the drive control signal, a drive signal output circuit that outputs the drive signal corresponding to the drive waveform information selected by the waveform selection circuit, and a detection circuit that detects a state of at least one of the printhead or the head controller, and the waveform selection circuit selects first drive waveform information as the drive waveform information in accordance with first drive information as the drive control signal and a first waveform information table among the plurality of waveform information tables, and selects second drive waveform information different from the first drive waveform information as the drive waveform information in accordance with the first drive information and a second waveform information table among the plurality of waveform information tables.

### BRIEF DESCRIPTION OF THE DRAWINGS

FIG. 1 is a diagram showing a schematic configuration of a liquid ejecting apparatus.

FIG. 2 is a diagram showing a schematic configuration of a head unit.

FIG. 3 is a diagram showing a schematic configuration of an ejecting portion.

FIG. 4 is a diagram showing an example of signal waveforms of drive signals.

FIG. 5 is a diagram showing a functional configuration of a drive signal selection circuit.

FIG. 6 is a diagram showing an example of decoded contents in a decoder.

FIG. 7 is a diagram showing an example of a configuration of a selection circuit.

FIG. 8 is a diagram for describing an operation of the drive signal selection circuit.

FIG. 9 is a diagram showing an example of a configuration of controlling the signal waveforms of the drive signals without changing information included in a drive control signal.

FIG. 10 is a diagram showing an example of a data configuration of the drive control signal.

FIG. 11 is a diagram showing an example of a data configuration of an internal drive control signal.

FIG. 12 is a diagram showing an example of a conversion table included in a conversion table signal.

FIG. 13 is a diagram showing an example of a relationship between waveform selection information and waveform information stored in a storage circuit.

FIG. 14 is a diagram showing a schematic configuration of a head unit of a second embodiment.

### DESCRIPTION OF EMBODIMENTS

Hereinafter, preferred embodiments of the present disclosure will be described with reference to the drawings. The drawings are used for convenience of description. The embodiments described below do not unduly limit the contents of the present disclosure according to the claims. In addition, not all configurations described below are essential requirements of the present disclosure.

### 1. First Embodiment

### 1.1 Schematic Configuration and Operation of Liquid Ejecting Apparatus

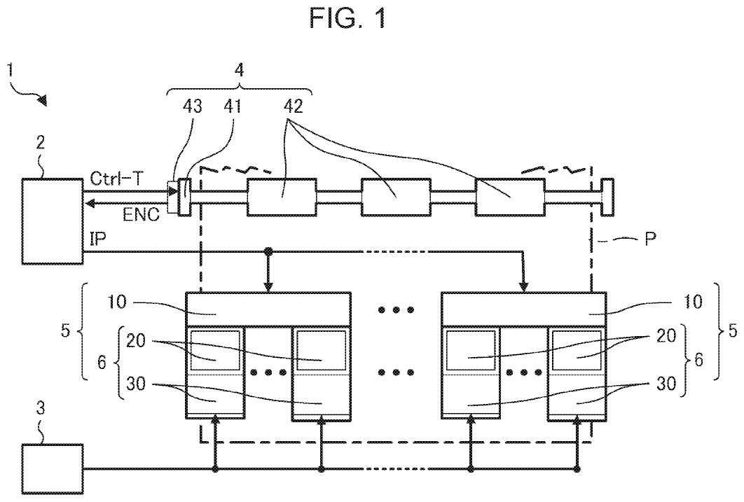

FIG. 1 is a diagram showing a schematic configuration of a liquid ejecting apparatus 1. As shown in FIG. 1, the liquid ejecting apparatus 1 is a so-called line-type ink jet printer that forms a desired image on a medium P transported by a transport unit 4 by ejecting an ink that is an example of a liquid, to the medium P at a desired timing. In the following description, a direction in which the medium P is transported may be referred to as a transport direction, and a width direction of the medium P being transported may be referred to as a main scanning direction.

As shown in FIG. 1, the liquid ejecting apparatus 1 includes a control unit 2, a liquid container 3, the transport unit 4, and a plurality of head units 5.

The control unit 2 includes a processing circuit such as a central processing unit (CPU) or a field programmable gate array (FPGA), and a storage circuit such as a semiconductor memory. The control unit 2 outputs a signal for controlling each element of the liquid ejecting apparatus 1 based on image data supplied from an external device such as a host computer, not shown, provided outside the liquid ejecting apparatus 1 and on an encoder signal ENC, which will be described later.

The liquid container 3 stores the ink as an example of the liquid supplied to the head units 5. Specifically, for example, the liquid container 3 stores inks of a plurality of colors, such as inks of black, cyan, magenta, and yellow, to be ejected to the medium P.

The transport unit 4 includes a transport motor 41, a transport roller 42, and an encoder 43. The transport unit 4 receives input of a transport control signal Ctrl-T output by the control unit 2. The transport motor 41 operates based on the transport control signal Ctrl-T, and the transport roller 42 is rotationally driven in connection with the operation of the transport motor 41. Accordingly, the medium P is transported along the transport direction. The encoder 43 generates the encoder signal ENC corresponding to a transport position of the medium P by detecting a rotation angle of at least one of the transport motor 41 or the transport roller 42, and outputs the encoder signal ENC to the control unit 2.

The plurality of head units 5 are configured to be attachable and interchangeable with respect to the liquid ejecting apparatus 1 and the control unit 2, and each of them includes a relay unit 10 and a plurality of ejecting units 6. Each of the plurality of ejecting units 6 includes a head drive module 20 and a liquid ejecting module 30. The head unit 5 receives input of an image information signal IP output by the control unit 2 and is supplied with the ink stored in the liquid container 3. The relay unit 10 and the plurality of head drive modules 20 control the plurality of liquid ejecting modules 30 based on the image information signal IP. The liquid ejecting module 30 ejects the ink supplied from the liquid container 3 to the medium P under control of the relay unit 10 and the plurality of head drive modules 20.

The liquid ejecting apparatus 1 of the first embodiment constitutes a line-type ink jet printer. Specifically, the plurality of liquid ejecting modules 30 are provided to extend over a width of the medium P or longer in the width direction which is the main scanning direction and intersects with the transport direction of the medium P being transported, so that the inks can be ejected to a whole region, in the width direction, of the medium P being transported. The ink is ejected from each of the plurality of liquid ejecting modules 30 in connection with the transport of the medium P, and the ink lands at a desired position on the medium P. Accordingly, a desired image is formed on the medium P.

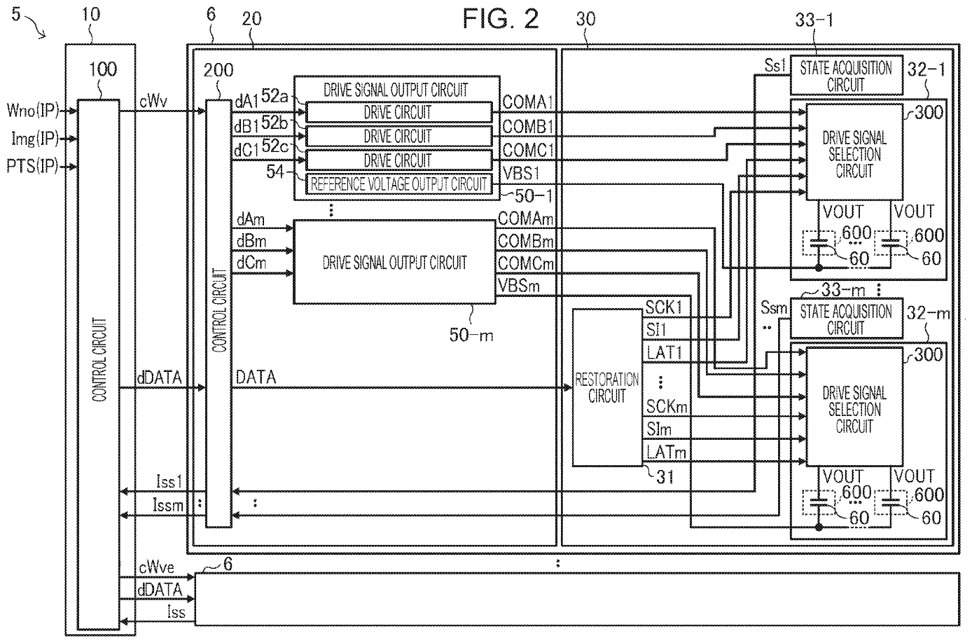

Next, a schematic configuration of the head unit 5 will be described. FIG. 2 is a diagram showing a schematic configuration of the head unit 5. As shown in FIG. 2, the head unit 5 includes the relay unit 10 and the ejecting unit 6. The ejecting unit 6 includes the head drive module 20 and the liquid ejecting module 30. Electrical coupling is made between the relay unit 10 and the ejecting unit 6 and between the head drive module 20 and the liquid ejecting module 30 by, for example, flexible printed circuits (FPC), a flexible flat cable (FFC), or a board to board (BtoB) connector.

The relay unit 10 includes a control circuit 100. The control circuit 100 receives input of an image data signal Img corresponding to the image data, a drive control signal Wno, and a timing signal PTS corresponding to the encoder signal ENC as the image information signal IP. The control circuit 100 generates a waveform selection signal cWv corresponding to each of the plurality of ejecting units 6 based on the timing signal PTS and the drive control signal Wno, and outputs the waveform selection signal cWv to the corresponding ejecting unit 6. The control circuit 100 also generates base data signal dDATA corresponding to each of the plurality of ejecting units 6 based on the timing signal PTS and the image data signal Img, and outputs the base data signal dDATA to the corresponding ejecting unit 6.

All of the plurality of ejecting units 6 have the same configuration. Thus, one ejecting unit 6 will be used for description, and other ejecting units 6 will not be shown or described. The ejecting unit 6 includes the head drive module 20 and the liquid ejecting module 30.

The head drive module 20 includes a control circuit 200 and drive signal output circuits 50-1 to 50-m.

The control circuit 200 includes a CPU, an FPGA, or the like. The control circuit 200 receives input of the waveform selection signal cWv and the base data signal dDATA output by the control circuit 100.

The control circuit 200 converts the base data signal dDATA into a differential signal of low voltage differential signaling (LVDS) or the like, and outputs the differential signal to the liquid ejecting module 30 as a data signal DATA. The control circuit 200 may convert the base data signal dDATA into a differential signal of a high-speed transmission method, such as low voltage positive emitter coupled logic (LVPECL) or current mode logic (CML), other than LVDS, and output the differential signal to the liquid ejecting module 30 as the data signal DATA. Alternatively, the control circuit 200 may output a part or a whole of the base data signal dDATA to the liquid ejecting module 30 as a single-ended data signal DATA.

The control circuit 200 also generates base drive signals dA1, dB1, and dC1 corresponding to the waveform selection signal cWv, and outputs the base drive signals dA1, dB1, and dC1 to the drive signal output circuit 50-1. The drive signal output circuit 50-1 includes drive circuits 52a, 52b, and 52c. The drive circuit 52a receives input of the base drive signal dA1. The drive circuit 52a generates a drive signal COMA1 by performing digital/analog conversion and then class-D amplification on the input base drive signal dA1, and outputs the drive signal COMA1 to the liquid ejecting module 30. The drive circuit 52b receives input of the base drive signal dB1. The drive circuit 52b generates a drive signal COMB1 by performing digital/analog conversion and then class-D amplification on the input base drive signal dB1, and outputs the drive signal COMB1 to the liquid ejecting module 30. The drive circuit 52c receives input of the base drive signal dC1. The drive circuit 52c generates a drive signal COMC1 by performing digital/analog conversion and then class-D amplification on the input base drive signal dC1, and outputs the drive signal COMC1 to the liquid ejecting module 30.

Each of the drive circuits 52a, 52b, and 52c only needs to generate the drive signals COMA1, COMB1, and COMC1 by amplifying waveforms defined by each of the input base drive signals dA1, dB1, and dC1. Thus, each of the drive circuits 52a, 52b, and 52c may include a class-A amplifier circuit, a class-B amplifier circuit, a class-AB amplifier circuit, or the like instead of a class-D amplifier circuit or in addition to a class-D amplifier circuit. In addition, the base drive signals dA1, dB1, and dC1 only need to define the waveforms of the corresponding drive signals COMA1, COMB1, and COMC1, respectively, and may be analog signals.

The drive signal output circuit 50-1 also includes a reference voltage output circuit 54. The reference voltage output circuit 54 generates a reference voltage signal VBS1 having a constant potential indicating a reference potential of a piezoelectric element 60, which will be described later, included in the liquid ejecting module 30, and outputs the reference voltage signal VBS1 to the liquid ejecting module 30. The reference voltage signal VBS1 may be, for example, a ground potential or a constant potential such as 5.5 V or 6 V. A constant potential includes a substantially constant potential after taking into consideration error such as a change in potential caused by an operation of a peripheral circuit, a change in potential caused by a variation in a circuit element, or a change in potential caused by a temperature characteristic of a circuit element.

The drive signal output circuits 50-2 to 50-m have the same configuration as the drive signal output circuit 50-1 except that input signals and output signals are different. The control circuit 200 generates base drive signals dAj, dBj, and dCj (j is any of 1 to m) corresponding to the waveform selection signal cWv, and outputs the base drive signals dAj, dBj, and dCj to a drive signal output circuit 50-j. The drive signal output circuit 50-j includes circuits corresponding to the drive circuits 52a, 52b, and 52c, and a circuit corresponding to the reference voltage output circuit 54. The drive signal output circuit 50-j generates drive signals COMAj, COMBj, and COMCj and a reference voltage signal VBSj based on the input base drive signals dAj, dBj, and dCj, and outputs the drive signals COMAj, COMBj, and COMCj and the reference voltage signal VBSj to the liquid ejecting module 30.

The liquid ejecting module 30 includes a restoration circuit 31, ejecting modules 32-1 to 32-m, and state acquisition circuits 33-1 to 33-m.

The restoration circuit 31 restores the data signal DATA to a single-ended signal, separates the single-ended signal into signals corresponding to each of the ejecting modules 32-1 to 32-m, and outputs the separated signals to the corresponding ejecting modules 32-1 to 32-m.

Specifically, the restoration circuit 31 generates a clock signal SCK1, a print data signal SI1, and a latch signal LAT1 corresponding to the ejecting module 32-1 by restoring and separating the data signal DATA, and outputs the clock signal SCK1, the print data signal SI1, and the latch signal LAT1 to the ejecting module 32-1. The restoration circuit 31 also generates a clock signal SCKj, a print data signal SIj, and a latch signal LATj corresponding to an ejecting module 32-j by restoring and separating the data signal DATA, and outputs the clock signal SCKj, the print data signal SIj, and the latch signal LATj to the ejecting module 32-j.

As described above, the restoration circuit 31 restores the data signal DATA of the differential signal output by the head drive module 20, and separates the restored signal into signals corresponding to the ejecting modules 32-1 to 32-m. Accordingly, the restoration circuit 31 generates clock signals SCK1 to SCKm, print data signals SI1 to SIm, and latch signals LAT1 to LATm corresponding to the ejecting modules 32-1 to 32-m, and outputs the clock signals SCK1 to SCKm, the print data signals SI1 to SIm, and the latch signals LAT1 to LATm to the corresponding ejecting modules 32-1 to 32-m. One of the clock signals SCK1 to SCKm, the print data signals SI1 to SIm, or the latch signals LAT1 to LATm corresponding to each of the ejecting modules 32-1 to 32-m output by the restoration circuit 31 may be a common signal corresponding to the ejecting modules 32-1 to 32-m.

According to the point of generating the clock signals SCK1 to SCKm, the print data signals SI1 to SIm, and the latch signals LAT1 to LATm by restoring and separating the data signal DATA via the restoration circuit 31, the data signal DATA output by the control circuit 200 is a differential signal corresponding to the clock signals SCK1 to SCKm, the print data signals SI1 to SIm, and the latch signals LAT1 to LATm, and the base data signal dDATA as a base of the data signal DATA includes signals corresponding to each of the clock signals SCK1 to SCKm, the print data signals SI1 to SIm, and the latch signals LAT1 to LATm.

The ejecting module 32-1 includes a drive signal selection circuit 300 and a plurality of ejecting portions 600. Each of the plurality of ejecting portions 600 includes the piezoelectric element 60.

The ejecting module 32-1 receives input of the drive signals COMA1, COMB1, and COMC1, the reference voltage signal VBS1, the clock signal SCK1, the print data signal SI1, and the latch signal LAT1. The drive signal selection circuit 300 included in the ejecting module 32-1 receives input of the drive signals COMA1, COMB1, and COMC1, the clock signal SCK1, the print data signal SI1, and the latch signal LAT1. The drive signal selection circuit 300 generates a drive signal VOUT by selecting or not selecting each of the drive signals COMA1, COMB1, and COMC1 based on the input clock signal SCK1, print data signal SI1, and latch signal LAT1, and supplies the drive signal VOUT to one end of the piezoelectric element 60 included in the corresponding ejecting portion 600. The other end of the piezoelectric element 60 is supplied with the reference voltage signal VBS1. The piezoelectric element 60 is driven by a difference in potential between the drive signal VOUT supplied to its one end and the reference voltage signal VBS1 supplied to its other end. Accordingly, the ink is ejected from the corresponding ejecting portion 600.

The ejecting module 32-j also includes the drive signal selection circuit 300 and the plurality of ejecting portions 600. Each of the plurality of ejecting portions 600 includes the piezoelectric element 60.

The ejecting module 32-j receives input of the drive signals COMAj, COMBj, and COMCj, the reference voltage signal VBSj, the clock signal SCKj, the print data signal SIj, and the latch signal LATj. The drive signal selection circuit 300 included in the ejecting module 32-j receives input of the drive signals COMAj, COMBj, and COMCj, the clock signal SCKj, the print data signal SIj, and the latch signal LATj. The drive signal selection circuit 300 generates the drive signal VOUT by selecting or not selecting each of the drive signals COMAj, COMBj, and COMCj based on the input clock signal SCKj, print data signal SIj, and latch signal LATj, and supplies the drive signal VOUT to one end of the piezoelectric element 60 included in the corresponding ejecting portion 600. The other end of the piezoelectric element 60 is supplied with the reference voltage signal VBSj. The piezoelectric element 60 is driven by a difference in potential between the drive signal VOUT supplied to its one end and the reference voltage signal VBSj supplied to its other end. Accordingly, the ink is ejected from the corresponding ejecting portion 600.

The state acquisition circuit 33-1 acquires a state of the ejecting module 32-1, generates a state signal Ss1 corresponding to the acquired state, and outputs the state signal Ss1. The state acquisition circuits 33-2 to 33-m also acquire states of the corresponding ejecting modules 32-2 to 32-m, generate state signals Ss2 to Ssm corresponding to the acquired states, and output the state signals Ss2 to Ssm. For example, a configuration of providing a temperature detection circuit, not shown, acquiring temperatures t of the ejecting modules 32-1 to 32-m via the temperature detection circuit as the states of the corresponding ejecting modules 32-2 to 32-m, and outputting signals corresponding to the acquired temperatures t as the state signals Ss1 to Ssm can be used as the state acquisition circuits 33-1 to 33-m.

The control circuit 200 receives input of the state signals Ss1 to Ssm output by the state acquisition circuits 33-1 to 33-m. The control circuit 200 generates state information signals Iss1 to Issm corresponding to the state signals Ss1 to Ssm and outputs the state information signals Iss1 to Issm to the control circuit 100. The control circuit 100 updates the waveform selection signal cWv in accordance with the input state information signals Iss1 to Issm, and outputs the updated waveform selection signal cWv to the control circuit 200 included in the corresponding ejecting unit 6. The control circuit 200 generates the base drive signals dA1 to dAm, dB1 to dBm, and dC1 to dCm corresponding to the input waveform selection signal cWv, and outputs the base drive signals dA1 to dAm, dB1 to dBm, and dC1 to dCm to the drive signal output circuits 50-1 to 50-m. Accordingly, signal waveforms of the drive signals COMA1 to COMAm, COMB1 to COMBm, and COMC1 to COMCm that are output by the drive signal output circuits 50-1 to 50-m and supplied to the liquid ejecting module 30 are updated in accordance with the states of the corresponding ejecting modules 32-1 to 32-m.

As described above, in the liquid ejecting apparatus 1 of the first embodiment, the control unit 2 controls the transport of the medium P by the transport unit 4 and the ejection of the ink from the liquid ejecting module 30 included in the head unit 5, based on the image data supplied from the host computer or the like, not shown. Accordingly, the liquid ejecting apparatus 1 can cause a desired amount of the ink to land at a desired position on the medium P. Therefore, a desired image is formed on the medium P.

That is, the liquid ejecting apparatus 1 of the first embodiment includes the ejecting modules 32-1 to 32-m that eject the ink as an example of the liquid in accordance with the drive signals COMA1 to COMAm, COMB1 to COMBm, and COMC1 to COMCm, the relay unit 10 that receives input of the drive control signal Wno and controls the ejection of the ink from the ejecting modules 32-1 to 32-m, and the head drive module 20.

The ejecting modules 32-1 to 32-m included in the liquid ejecting module 30 have the same configuration except that input signals are different. Thus, in the following description, the ejecting modules 32-1 to 32-m may be simply referred to as an ejecting module 32 unless otherwise necessary to distinguish therebetween. In this case, the drive signals COMA1 to COMAm input into the ejecting module 32 may be referred to as a drive signal COMA. The drive signals COMB1 to COMBm input into the ejecting module 32 may be referred to as a drive signal COMB. The drive signals COMC1 to COMCm input into the ejecting module 32 may be referred to as a drive signal COMC. The reference voltage signals VBS1 to VBSm input into the ejecting module 32 may be referred to as a reference voltage signal VBS. The clock signals SCK1 to SCKm input into the ejecting module 32 may be referred to as a clock signal SCK. The print data signals SI1 to SIm input into the ejecting module 32 may be referred to as a print data signal SI. The latch signals LAT1 to LATm input into the ejecting module 32 may be referred to as a latch signal LAT. In addition, the drive signal output circuits 50-1 to 50-m have the same configuration except that input signals are different. Thus, in the following description, the drive signal output circuits 50-1 to 50-m may be simply referred to as a drive signal output circuit 50 unless otherwise necessary to distinguish therebetween. In this case, the drive signal output circuit 50 receives input of a base drive signal dA as the base drive signals dA1 to dAm, a base drive signal dB as the base drive signals dB1 to dBm, and a base drive signal dC as the base drive signals dC1 to dCm. The drive signal output circuit 50 outputs the drive signal COMA as the drive signals COMA1 to COMAm, the drive signal COMB as the drive signals COMB1 to COMBm, the drive signal COMC as the drive signals COMC1 to COMCm, and the reference voltage signal VBS as the reference voltage signals VBS1 to VBSm.

### 1.2 Configuration and Operation of Ejecting Module

### 1.2.1 Configuration of Ejecting Portion

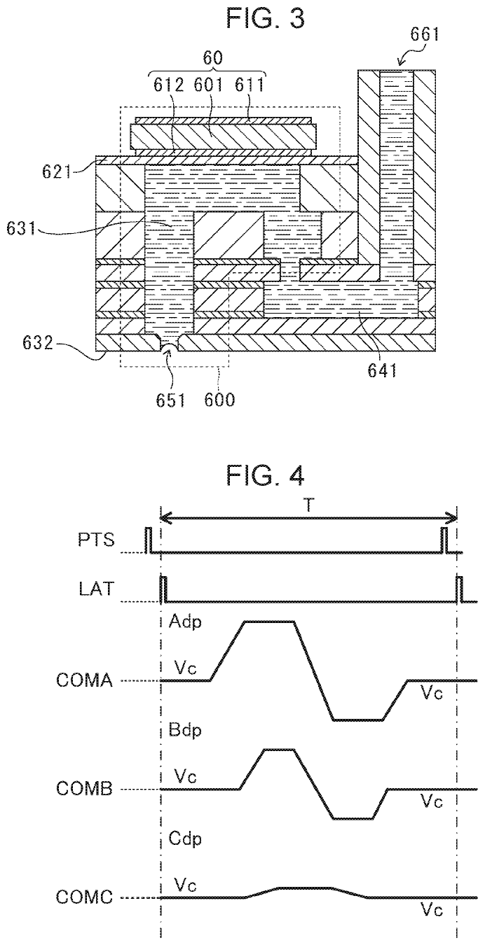

FIG. 3 is a diagram showing a schematic configuration of one of the plurality of ejecting portions 600 included in the ejecting module 32. As shown in FIG. 3, the ejecting portion 600 includes the piezoelectric element 60, a vibrating plate 621, a cavity 631, and a nozzle 651.

The cavity 631 is filled with the ink supplied from a reservoir 641. The ink is poured into the reservoir 641 from the liquid container 3 via an ink tube, not shown, and a supply port 661. That is, the cavity 631 is filled with the ink supplied from the liquid container 3. The vibrating plate 621 is displaced by driving the piezoelectric element 60 provided on its upper surface in FIG. 3. An internal volume of the cavity 631 expands or reduces in connection with the displacement of the vibrating plate 621. The nozzle 651 is an open hole portion that is provided in a nozzle plate 632 and communicates with the cavity 631. The internal volume of the cavity 631 changes in connection with a change in the vibrating plate 621. Accordingly, an amount of the ink corresponding to a change in the internal volume of the cavity 631 is ejected from the nozzle 651. The piezoelectric element 60 includes a piezoelectric body 601 and a pair of electrodes 611 and 612. The pair of electrodes 611 and 612 are provided such that the piezoelectric body 601 is sandwiched therebetween. The piezoelectric body 601 bends in a top-to-bottom direction together with the vibrating plate 621 in accordance with a difference in potential between voltages supplied to the electrodes 611 and 612.

In the ejecting portion 600 configured as described above, when the piezoelectric element 60 bends upward, the vibrating plate 621 is displaced upward, and the internal volume of the cavity 631 expands. Accordingly, the ink stored in the reservoir 641 is drawn into the cavity 631. On the other hand, when the piezoelectric element 60 bends downward, the vibrating plate 621 is displaced downward, and the internal volume of the cavity 631 reduces. Accordingly, an amount of the ink corresponding to a degree of the reduction is ejected from the nozzle 651. The piezoelectric element 60 included in the ejecting portion 600 is not limited to having a structure of flexural vibration as shown in FIG. 3, and may have, for example, a structure of longitudinal vibration.

### 1.2.2 Functional Configuration of Drive Signal Selection Circuit

Next, a configuration and an operation of the drive signal selection circuit 300 included in the ejecting module 32 will be described. In describing the configuration and the operation of the drive signal selection circuit 300 included in the ejecting module 32, first, an example of signal waveforms included in the drive signals COMA, COMB, and COMC input into the drive signal selection circuit 300 will be described.

FIG. 4 is a diagram showing an example of the signal waveforms of the drive signals COMA, COMB, and COMC. As shown in FIG. 4, the drive signal COMA includes a trapezoidal waveform Adp arranged in a cycle T from a rise of the latch signal LAT to a subsequent rise of the latch signal LAT. The trapezoidal waveform Adp is a signal waveform that is supplied to one end of the piezoelectric element 60 to eject a predetermined amount of the ink from the ejecting portion 600 corresponding to the piezoelectric element 60. The drive signal COMB includes a trapezoidal waveform Bdp arranged in the cycle T. The trapezoidal waveform Bdp is a signal waveform that has a lower voltage amplitude than the trapezoidal waveform Adp and is supplied to one end of the piezoelectric element 60 to eject a smaller amount of the ink than the predetermined amount from the ejecting portion 600 corresponding to the piezoelectric element 60. The drive signal COMC includes a trapezoidal waveform Cdp arranged in the cycle T. The trapezoidal waveform Cdp is a signal waveform that has a lower voltage amplitude than the trapezoidal waveforms Adp and Bdp and is supplied to one end of the piezoelectric element 60 to vibrate the ink near the open hole portion of the nozzle to an extent that the ink is not ejected from the ejecting portion 600 corresponding to the piezoelectric element 60. The trapezoidal waveform Cdp is supplied to the piezoelectric element 60 to vibrate the ink near the open hole portion of the nozzle of the ejecting portion 600 including the piezoelectric element 60. Accordingly, viscosity of the ink near the open hole portion of the nozzle is less likely to increase.

At a start timing and an end timing of each of the trapezoidal waveforms Adp, Bdp, and Cdp, all of the trapezoidal waveforms Adp, Bdp, and Cdp have a common voltage value corresponding to a voltage Vc. That is, each of the trapezoidal waveforms Adp, Bdp, and Cdp is a signal waveform that starts at the voltage Vc and ends at the voltage Vc. The voltage Vc at the start timing and the end timing of each of the trapezoidal waveforms Adp, Bdp, and Cdp may be referred to as an intermediate potential.

In the following description, an amount of the ink ejected from the ejecting portion 600 corresponding to the piezoelectric element 60 when the trapezoidal waveform Adp is supplied to one end of the piezoelectric element 60 may be referred to as a large amount. An amount of the ink ejected from the ejecting portion 600 corresponding to the piezoelectric element 60 when the trapezoidal waveform Bdp is supplied to one end of the piezoelectric element 60 may be referred to as a small amount. Vibrating the ink near the open hole portion of the nozzle to the extent that the ink is not ejected from the ejecting portion 600 corresponding to the piezoelectric element 60 when the trapezoidal waveform Cdp is supplied to one end of the piezoelectric element 60 may be referred to as microvibration.

The signal waveforms included in the drive signals COMA, COMB, and COMC are not limited to the signal waveforms shown in FIG. 4, and various signal waveforms may be used in accordance with a type of the ink ejected from the ejecting portion 600, the number of piezoelectric elements 60 driven by the drive signals COMA, COMB, and COMC, a length of wiring through which the drive signals COMA, COMB, and COMC propagate, the temperature of the ejecting module 32 including the ejecting portion 600, and the like. That is, the drive signals COMA1 to COMAm may have different signal waveforms from each other, the drive signals COMB1 to COMBm may have different signal waveforms from each other, and the drive signals COMC1 to COMCm may have different signal waveforms from each other.

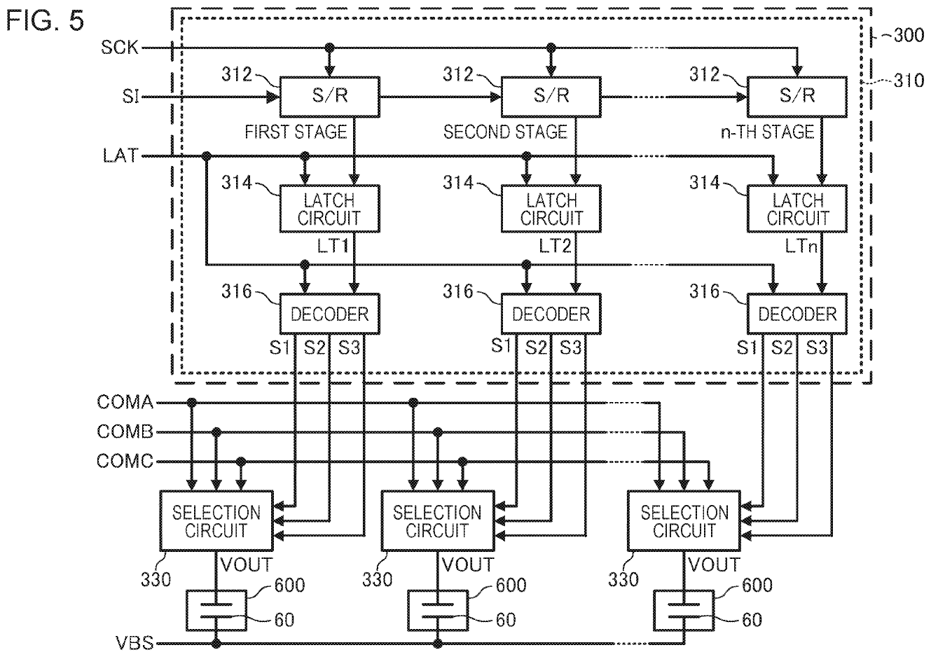

Next, a configuration and an operation of the drive signal selection circuit 300 that outputs the drive signal VOUT by selecting or not selecting each of the drive signals COMA, COMB, and COMC will be described. FIG. 5 is a diagram showing a functional configuration of the drive signal selection circuit 300. As shown in FIG. 5, the drive signal selection circuit 300 includes a selection control circuit 310 and a plurality of selection circuits 330.

The selection control circuit 310 receives input of the print data signal SI, the latch signal LAT, and the clock signal SCK. The selection control circuit 310 includes a set of a shift register (S/R) 312, a latch circuit 314, and a decoder 316 corresponding to each of n ejecting portions 600. That is, the drive signal selection circuit 300 includes n shift registers 312, n latch circuits 314, and n decoders 316 corresponding to the total number of ejecting portions 600.

The print data signal SI is a signal synchronized with the clock signal SCK and includes 2-bit print data [SIH, SIL] for defining a dot size to be formed by the ink ejected from each of the n ejecting portions 600 as one of “large dot LD”, “small dot SD”, “no ejection ND”, and “microvibration BSD”. The print data signal SI is held in the shift register 312 corresponding to the ejecting portion 600 for each 2-bit print data [SIH, SIL].

Specifically, the n shift registers 312 corresponding to the ejecting portions 600 are coupled to each other in a cascade manner. The print data signal SI that is serially input is sequentially transmitted to a subsequent stage of the shift registers 312 coupled in a cascade manner, in accordance with the clock signal SCK. When the supply of the clock signal SCK stops, the n shift registers 312 hold the 2-bit print data [SIH, SIL] corresponding to the ejecting portions 600 corresponding to the shift registers 312. For distinction, FIG. 5 shows the n shift registers 312 coupled in a cascade manner as a first stage, a second stage, . . . , an n-th stage from an upstream point at which the print data signal SI is input, to a downstream point.

Each of the n latch circuits 314 simultaneously latches the 2-bit print data [SIH, SIL] held by the corresponding shift register 312 at a rise of the latch signal LAT.

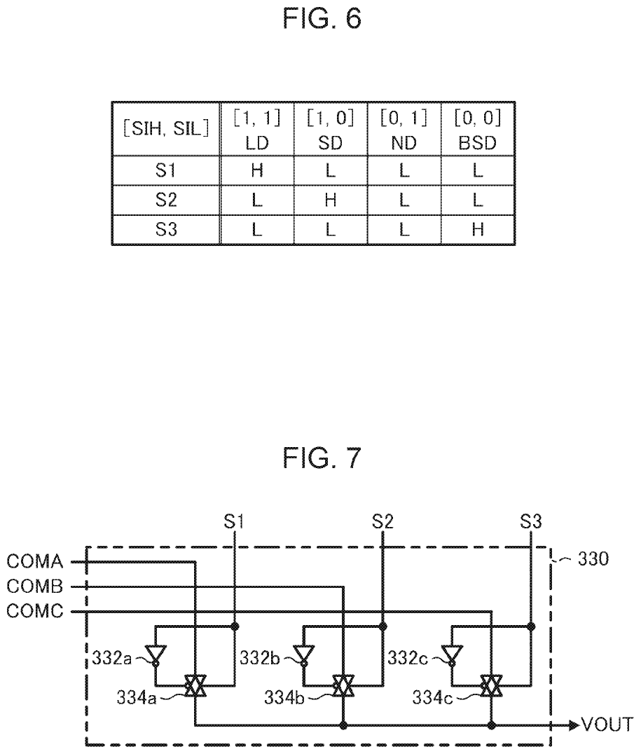

Each of the n decoders 316 decodes the 2-bit print data [SIH, SIL] latched by the corresponding latch circuit 314, and outputs selection signals S1, S2, and S3 having logic levels corresponding to decoded contents, for each cycle T. FIG. 6 is a diagram showing an example of the decoded contents in the decoder 316. The decoder 316 outputs the selection signals S1, S2, and S3 having logic levels defined by the latched 2-bit print data [SIH, SIL] and the decoded contents shown in FIG. 6. For example, when the 2-bit print data [SIH, SIL] latched by the corresponding latch circuit 314 is [1, 0], the decoder 316 sets the logic levels of the selection signals S1, S2, and S3 to levels L, H, and L, respectively, in the cycle T.

The selection circuit 330 is provided in accordance with each of the n ejecting portions 600. That is, the drive signal selection circuit 300 includes n selection circuits 330. The selection circuit 330 receives input of the selection signals S1, S2, and S3 output by the decoder 316 corresponding to the same ejecting portion 600 and the drive signals COMA, COMB, and COMC. The selection circuit 330 generates the drive signal VOUT by selecting or not selecting each of the drive signals COMA, COMB, and COMC based on the selection signals S1, S2, and S3 and the drive signals COMA, COMB, and COMC, and outputs the drive signal VOUT to the corresponding ejecting portion 600.

FIG. 7 is a diagram showing an example of a configuration of the selection circuit 330 corresponding to one ejecting portion 600. As shown in FIG. 7, the selection circuit 330 includes inverters 332a, 332b, and 332c and transfer gates 334a, 334b, and 334c.

The selection signal S1 is input into a positive control terminal not marked with a circle in the transfer gate 334a, and is logically inverted by the inverter 332a and is input into a negative control terminal marked with a circle in the transfer gate 334a. An input terminal of the transfer gate 334a is supplied with the drive signal COMA. In the transfer gate 334a, the input terminal and an output terminal are conductive to each other when the input selection signal S1 is at level H, and the input terminal and the output terminal are not conductive to each other when the input selection signal S1 is at level L. That is, the transfer gate 334a outputs the drive signal COMA to the output terminal when the selection signal S1 is at level H, and does not output the drive signal COMA to the output terminal when the selection signal S1 is at level L.

The selection signal S2 is input into a positive control terminal not marked with a circle in the transfer gate 334b, and is logically inverted by the inverter 332b and is input into a negative control terminal marked with a circle in the transfer gate 334b. An input terminal of the transfer gate 334b is supplied with the drive signal COMB. In the transfer gate 334b, the input terminal and an output terminal are conductive to each other when the input selection signal S2 is at level H, and the input terminal and the output terminal are not conductive to each other when the input selection signal S2 is at level L. That is, the transfer gate 334b outputs the drive signal COMB to the output terminal when the selection signal S2 is at level H, and does not output the drive signal COMB to the output terminal when the selection signal S2 is at level L.

The selection signal S3 is input into a positive control terminal not marked with a circle in the transfer gate 334c, and is logically inverted by the inverter 332c and is input into a negative control terminal marked with a circle in the transfer gate 334c. An input terminal of the transfer gate 334c is supplied with the drive signal COMC. In the transfer gate 334c, the input terminal and an output terminal are conductive to each other when the input selection signal S3 is at level H, and the input terminal and the output terminal are not conductive to each other when the input selection signal S3 is at level L. That is, the transfer gate 334c outputs the drive signal COMC to the output terminal when the selection signal S3 is at level H, and does not output the drive signal COMC to the output terminal when the selection signal S3 is at level L.

The output terminals of the transfer gates 334a, 334b, and 334c are coupled in common. That is, the output terminals of the transfer gates 334a, 334b, and 334c coupled in common are supplied with the drive signals COMA, COMB, and COMC that are selected or not selected based on the selection signals S1, S2, and S3. The selection circuit 330 outputs the signal supplied to the output terminals coupled in common to the corresponding ejecting portion 600 as the drive signal VOUT.

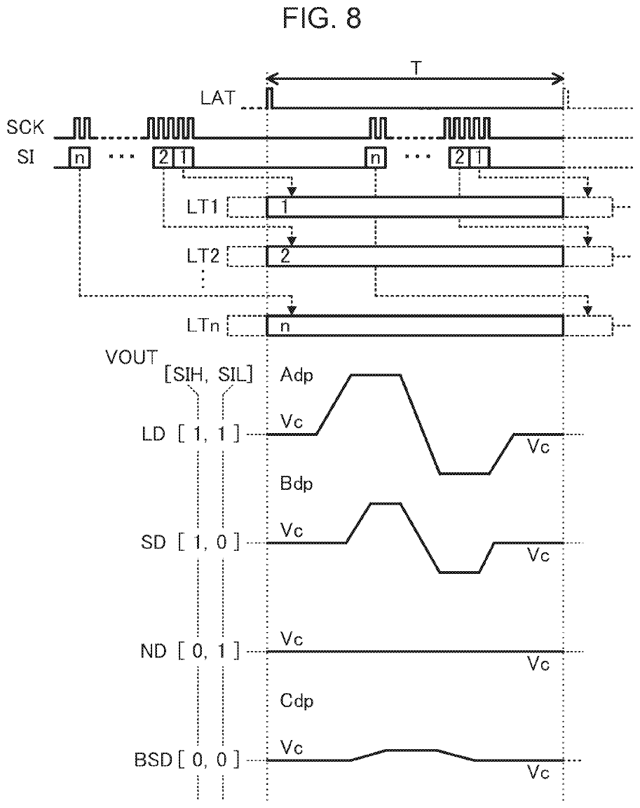

An operation of the drive signal selection circuit 300 will be described. FIG. 8 is a diagram showing an operation of the drive signal selection circuit 300. The print data signal SI is serially input in synchronization with the clock signal SCK, and is sequentially transmitted by the shift registers 312 corresponding to the ejecting portions 600. When the input of the clock signal SCK stops, the 2-bit print data [SIH, SIL] corresponding to each of the ejecting portions 600 is held in the corresponding shift registers 312.

Then, when the latch signal LAT rises, the 2-bit print data [SIH, SIL] held in the shift registers 312 are simultaneously latched by the latch circuits 314. FIG. 8 shows the 2-bit print data [SIH, SIL] latched by the latch circuits 314 and corresponding to the shift registers 312 of the first stage, the second stage, . . . , the n-th stage as LT1, LT2, . . . , LTn.

The decoder 316 outputs the selection signals S1, S2, and S3 having the logic levels defined by the latched 2-bit print data [SIH, SIL].

Specifically, when the print data [SIH, SIL] is [1, 1], the decoder 316 outputs the logic levels of the selection signals S1, S2, and S3 to the selection circuit 330 in the cycle T as levels H, L, and L, respectively. Accordingly, the selection circuit 330 selects the trapezoidal waveform Adp in the cycle T, and outputs the drive signal VOUT corresponding to “large dot LD”. When the print data [SIH, SIL] is [1, 0], the decoder 316 outputs the logic levels of the selection signals S1, S2, and S3 to the selection circuit 330 in the cycle T as levels L, H, and L, respectively. Accordingly, the selection circuit 330 selects the trapezoidal waveform Bdp in the cycle T, and outputs the drive signal VOUT corresponding to “small dot SD”. When the print data [SIH, SIL] is [0, 1], the decoder 316 outputs the logic levels of the selection signals S1, S2, and S3 to the selection circuit 330 in the cycle T as levels L, L, and L, respectively. Accordingly, the selection circuit 330 does not select any of the trapezoidal waveforms Adp, Bdp, and Cdp in the cycle T, and outputs the drive signal VOUT corresponding to “no ejection ND” that is constant at the voltage Vc. When the print data [SIH, SIL] is [0, 0], the decoder 316 outputs the logic levels of the selection signals S1, S2, and S3 to the selection circuit 330 in the cycle T as levels L, L, and H, respectively. Accordingly, the selection circuit 330 selects the trapezoidal waveform Cdp in the cycle T, and outputs the drive signal VOUT corresponding to “microvibration BSD”.

When the selection circuit 330 does not select any of the trapezoidal waveforms Adp, Bdp, and Cdp, the voltage Vc supplied to the piezoelectric element 60 immediately previously is held at one end of the corresponding piezoelectric element 60 by a capacitive component of the piezoelectric element 60. That is, the output of the drive signal VOUT that is constant at the voltage Vc by the selection circuit 330 includes the supply of the immediately previous voltage Vc held by the capacitive component of the piezoelectric element 60 to the piezoelectric element 60 as the drive signal VOUT, when none of the trapezoidal waveforms Adp, Bdp, and Cdp is selected as the drive signal VOUT.

As described above, the drive signal selection circuit 300 generates the drive signal VOUT corresponding to each of the plurality of ejecting portions 600 by selecting or not selecting the drive signals COMA, COMB, and COMC based on the print data signal SI, the latch signal LAT, and the clock signal SCK, and outputs the drive signal VOUT to the corresponding ejecting portion 600. Accordingly, the amount of the ink ejected from each of the plurality of ejecting portions 600 is individually controlled.

That is, the drive signals COMA, COMB, and COMC include the trapezoidal waveforms Adp, Bdp, and Cdp for each cycle T defined by the latch signal LAT. The drive signal selection circuit 300 generates n drive signals VOUT corresponding to the n ejecting portions 600 by selecting one of the trapezoidal waveforms Adp, Bdp, and Cdp or not selecting any thereof for each cycle T defined by the latch signal LAT, and outputs the n drive signals VOUT to the corresponding ejecting portions 600. In other words, the ejecting module 32 forms dots having a desired size on the medium P for each cycle T defined by the latch signal LAT. The latch signal LAT is defined by the timing signal PTS corresponding to the encoder signal ENC based on the transport position of the medium P. That is, the timing signal PTS is a signal for defining an ejection timing of the ink from the ejecting module 32, which is a timing of operation of the liquid ejecting apparatus 1.

### 1.3 Waveform Selection of Drive Signal

In the liquid ejecting apparatus 1 configured as described above, an ejection characteristic of the ink from the ejecting module 32 may change depending on a state of the ejecting module 32. For example, when a temperature of the ink stored in the ejecting module 32, which is the temperature of the ejecting module 32, changes, physical properties of the ink change. Accordingly, the ejection characteristic of the ink from the ejecting module 32 changes even when the drive signal VOUT having the same signal waveform is supplied to the ejecting portion 600. The ejection characteristic of the ink from the ejecting module 32 is also affected by, for example, an ejection cycle in which the ejecting module 32 ejects the ink to the medium P, which is an operation mode of the liquid ejecting apparatus 1. Therefore, from a viewpoint of improving quality of the image formed on the medium P by the liquid ejecting apparatus 1, the drive signal output circuit 50 is required to output the drive signals COMA, COMB, and COMC having an optimal waveform shape corresponding to, for example, the temperature of the ink stored in the ejecting module 32, which is the state of the ejecting module 32, or the operation mode of the liquid ejecting apparatus 1.

To meet such a requirement, the liquid ejecting apparatus 1 of the related art generally uses a configuration of controlling the signal waveforms of the drive signals COMA, COMB, and COMC output by the drive signal output circuit 50 under control of a configuration corresponding to the control unit 2. However, in such a configuration, when the head unit 5 that is attachable and interchangeable with respect to the liquid ejecting apparatus 1 and the control unit 2 as shown in the first embodiment is used, control specifications of the control unit 2 need to be changed in accordance with specifications of the used head unit 5. Accordingly, versatility of the control unit 2 and the head unit 5 is likely to decrease. Furthermore, when the above configuration is applied, a load required for processing in the control unit 2 is likely to increase when the number of head units 5 used in the liquid ejecting apparatus 1 increases.

In view of such an issue, the liquid ejecting apparatus 1 of the present embodiment can control the signal waveforms of the drive signals COMA, COMB, and COMC output by the drive signal output circuit 50 to change to the optimal signal waveform in accordance with the state of the ejecting module 32 independently of the control of the control unit 2. Therefore, for example, even when the temperature of the ink ejected from the ejecting module 32 changes, the signal waveforms of the drive signals COMA, COMB, and COMC output by the drive signal output circuit 50 can be controlled to change to the optimal waveform shape without changing information included in the drive control signal Wno corresponding to the operation mode of the liquid ejecting apparatus 1 output by the control unit 2, and the versatility of the liquid ejecting apparatus 1 and the head unit 5 can be increased.

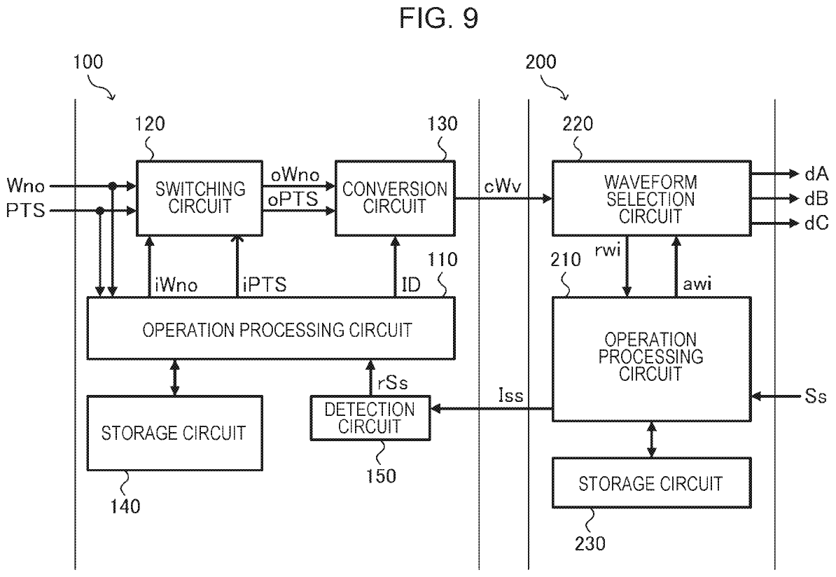

A specific example and an operation of such a configuration will be described. FIG. 9 is a diagram showing an example of a configuration of controlling the signal waveforms of the drive signals COMA, COMB, and COMC without changing the information included in the drive control signal Wno. As shown in FIG. 9, the configuration of controlling the signal waveforms of the drive signals COMA, COMB, and COMC without changing the information included in the drive control signal Wno includes an operation processing circuit 110, a switching circuit 120, a conversion circuit 130, a storage circuit 140, and a detection circuit 150 included in the control circuit 100, and an operation processing circuit 210, a waveform selection circuit 220, and a storage circuit 230 included in the control circuit 200.

The operation processing circuit 210 included in the control circuit 200 receives input of the state signals Ss1 to Ssm corresponding to the temperatures t of the ejecting modules 32-1 to 32-m, which are the states of the ejecting modules 32-1 to 32-m output by the state acquisition circuits 33-1 to 33-m. The operation processing circuit 210 acquires the state signals Ss1 to Ssm in response to a request from the operation processing circuit 110 or at a predetermined timing defined in advance. The operation processing circuit 210 generates the state information signals Iss1 to Issm corresponding to the acquired state signals Ss1 to Ssm, and outputs the state information signals Iss1 to Issm to the detection circuit 150 included in the control circuit 100. When the input state signals Ss1 to Ssm are analog signals, the operation processing circuit 210 may generate the state information signals Iss1 to Issm obtained by converting the analog signals into digital signals corresponding to the analog signals, and output the state information signals Iss1 to Issm to the detection circuit 150. Alternatively, the operation processing circuit 210 may output signals obtained by converting the input state signals Ss1 to Ssm into signals complying with communication specifications with which communication can be performed between the operation processing circuit 210 and the detection circuit 150, to the detection circuit 150 as the state information signals Iss1 to Issm. The operation processing circuit 210 may also output the input state signals Ss1 to Ssm to the detection circuit 150 as the state information signals Iss1 to Issm without conversion.

The detection circuit 150 detects the temperatures t of the corresponding ejecting modules 32-1 to 32-m, which are the states of the corresponding ejecting modules 32-1 to 32-m, based on the state information signals Iss1 to Issm. The detection circuit 150 generates state detection signals rSs1 to rSsm corresponding to a detection result and outputs the state detection signals rSs1 to rSsm.

In FIG. 9, the state signals Ss1 to Ssm are simply shown as a state signal Ss without distinction. The state information signals Iss1 to Issm are simply shown as a state information signal Iss without distinction. The state detection signals rSs1 to rSsm are simply shown as a state detection signal rSs without distinction.

The operation processing circuit 110 receives input of the state detection signal rSs, the drive control signal Wno including waveform selection information wn, which will be described later, and the timing signal PTS. The operation processing circuit 110 reads waveform selection information iwn, which will be described later, from the storage circuit 140 in accordance with the drive control signal Wno and the timing signal PTS. The operation processing circuit 110 generates an internal drive control signal iWno including the read waveform selection information iwn, and outputs the internal drive control signal iWno. The operation processing circuit 110 also generates an internal timing signal iPTS based on a clock signal generated by a clock circuit, not shown, and outputs the internal timing signal iPTS. The operation processing circuit 110 selects one of a plurality of conversion tables id stored in the storage circuit 140 in accordance with the temperature t of the ejecting module 32, which is the state of the ejecting module 32 based on the state detection signal rSs, and reads the selected conversion table id. The operation processing circuit 110 generates a conversion table signal ID including the read conversion table id, and outputs the conversion table signal ID.

The switching circuit 120 receives input of the drive control signal Wno including the waveform selection information wn, the timing signal PTS, the internal drive control signal iWno including the waveform selection information iwn, and the internal timing signal iPTS. The switching circuit 120 switches between selecting the waveform selection information wn and selecting the waveform selection information iwn by switching between selecting the drive control signal Wno and selecting the internal drive control signal iWno. The switching circuit 120 generates a drive control signal oWno including waveform selection information own corresponding to the selected waveform selection information wn or waveform selection information iwn, and outputs the drive control signal oWno. The switching circuit 120 switches between selecting the timing signal PTS and selecting the internal timing signal iPTS. The switching circuit 120 generates a timing signal oPTS corresponding to the selected timing signal PTS or internal timing signal iPTS, and outputs the timing signal oPTS.

The conversion circuit 130 receives input of the drive control signal oWno including the waveform selection information own, the timing signal oPTS, and the conversion table signal ID including the conversion table id. The conversion circuit 130 generates waveform selection information cwv by converting the waveform selection information own included in the drive control signal oWno in accordance with the conversion table id included in the conversion table signal ID in a cycle defined by the timing signal oPTS. The conversion circuit 130 generates the waveform selection signal cWv including the generated waveform selection information cwv, and outputs the waveform selection signal cWv.

The waveform selection circuit 220 receives input of the waveform selection signal cWv including the waveform selection information cwv. The waveform selection circuit 220 outputs the waveform selection information cwv included in the waveform selection signal cWv to the operation processing circuit 210 as a waveform designation signal rwi. The operation processing circuit 210 reads waveform information wi corresponding to the waveform selection information cwv included in the waveform designation signal rwi from the storage circuit 230. The operation processing circuit 210 generates a waveform information signal awi including the read waveform information wi, and outputs the waveform information signal awi to the waveform selection circuit 220. The waveform selection circuit 220 generates the base drive signals dA, dB, and dC corresponding to the waveform information wi included in the input waveform information signal awi, and outputs the base drive signals dA, dB, and dC. The drive signal output circuit 50 receives input of the base drive signals dA, dB, and dC output by the waveform selection circuit 220. Accordingly, the drive signal output circuit 50 outputs the drive signals COMA, COMB, and COMC having signal waveforms defined by the waveform information wi.

A specific example of an operation of the configuration of controlling the signal waveforms of the drive signals COMA, COMB, and COMC without changing the information included in the drive control signal Wno as configured above will be described. The liquid ejecting apparatus 1 of the present embodiment described here has a boot mode, a sleep mode, a standby mode, a start-up mode, an end-down mode, a forced microvibration mode, and an ejection mode as operation modes. The ejection mode described here includes a normal ejection mode, a high-speed ejection mode, and a high-definition ejection mode.

The boot mode is a mode for starting the operation of the liquid ejecting apparatus 1. The sleep mode is an operation mode in which the ink is not ejected to the medium P, and power consumption of the liquid ejecting apparatus 1 is reduced by setting the voltage values of the drive signals COMA, COMB, and COMC to be constant at a voltage Vos lower than the voltage Vc. The standby mode is an operation mode in which the ink is not ejected to the medium P, and the ink can be ejected to the medium P in a short time by setting the voltage values of the drive signals COMA, COMB, and COMC to be constant at the voltage Vc. The start-up mode is an operation mode for transitioning from the sleep mode to the standby mode. The end-down mode is an operation mode for transitioning from the standby mode to the sleep mode. The forced microvibration mode is an operation mode in which the plurality of ejecting portions 600 included in the ejecting module 32 are forced to execute microvibration. The ejection mode is an operation mode in which the ink can be ejected to the medium P. The normal ejection mode included in the ejection mode is an operation mode for forming an image having normal image quality on the medium P. The high-speed ejection mode included in the ejection mode is an operation mode for forming an image on the medium P at a higher speed than the normal ejection mode. The high-definition ejection mode included in the ejection mode is an operation mode for forming an image having higher definition than the normal ejection mode on the medium P.

The operation modes of the liquid ejecting apparatus 1 are not limited to the above and may include, for example, an inspection mode for inspecting states of the ejecting module 32 and the ejecting portion 600 included in the ejecting module 32, and a maintenance mode for executing maintenance processing on the ejecting portion 600 included in the ejecting module 32. The ejection mode may include a normal ejection mode, a high-speed ejection mode, and a high-definition ejection mode corresponding to each of a type of the medium P on which the ink lands, a usage environment, and the like.

In describing an example of the operation of the configuration of controlling the signal waveforms of the drive signals COMA, COMB, and COMC without changing the information included in the drive control signal Wno, first, an example of the waveform selection information wn included in the drive control signal Wno, an example of the waveform selection information iwn included in the internal drive control signal iWno, an example of the conversion table id included in the conversion table signal ID, and an example of a relationship between the waveform selection information cwv and the waveform information wi stored in the storage circuit 230 will be described.

FIG. 10 is a diagram showing an example of a data configuration of the drive control signal Wno. The drive control signal Wno includes 4-bit waveform selection information wn for defining the signal waveforms of the drive signals COMA, COMB, and COMC in accordance with the operation mode of the liquid ejecting apparatus 1.

As shown in FIG. 10, when the operation mode of the liquid ejecting apparatus 1 is the boot mode, the control unit 2 outputs the drive control signal Wno including the waveform selection information wn=[0×F]. When the operation mode of the liquid ejecting apparatus 1 is the forced microvibration mode, the control unit 2 outputs the drive control signal Wno including the waveform selection information wn=[0×4]. When the operation mode of the liquid ejecting apparatus 1 is the normal ejection mode, the control unit 2 outputs the drive control signal Wno including the waveform selection information wn=[0×5]. When the operation mode of the liquid ejecting apparatus 1 is the high-speed ejection mode, the control unit 2 outputs the drive control signal Wno including the waveform selection information wn=[0×6]. When the operation mode of the liquid ejecting apparatus 1 is the high-definition ejection mode, the control unit 2 outputs the drive control signal Wno including the waveform selection wn=[0×7].

When the ejection mode among the operation modes of the liquid ejecting apparatus 1 includes the normal ejection mode, the high-speed ejection mode, and the high-definition ejection mode corresponding to each of the type of the medium P on which the ink lands, the usage environment, and the like, the drive control signal Wno output by the control unit 2 may include the waveform selection information wn corresponding to each operation mode. While the example in FIG. 10 shows not assigning the waveform selection information wn corresponding to each of the sleep mode, the standby mode, the start-up mode, and the end-down mode to the drive control signal Wno output by the control unit 2, the control unit 2 may assign the waveform selection information wn corresponding to each of the sleep mode, the standby mode, the start-up mode, and the end-down mode to the drive control signal Wno, and output the drive control signal Wno including the waveform selection information wn corresponding to the operation mode. While the example in FIG. 10 shows the 4-bit waveform selection information wn included in the drive control signal Wno, the waveform selection information wn is not limited to 4 bits and may be 5 bits or more or 3 bits or less.

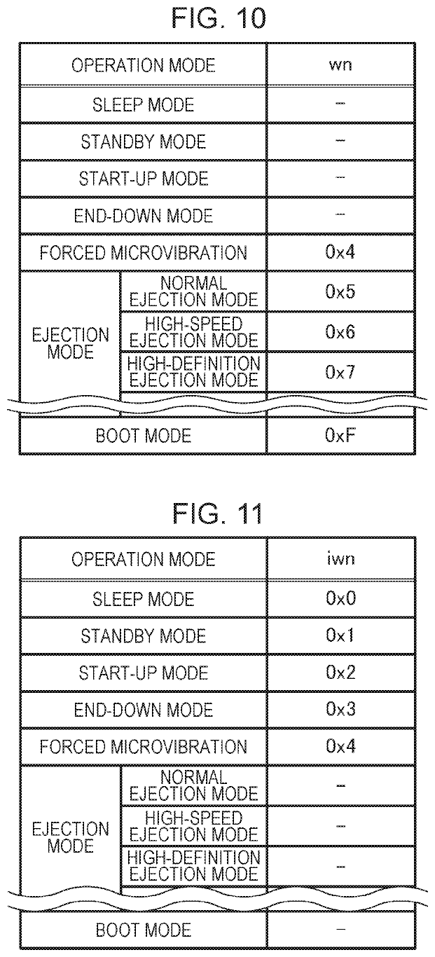

FIG. 11 is a diagram showing an example of a data configuration of the internal drive control signal iWno. The internal drive control signal iWno includes 4-bit waveform selection information iwn for defining the signal waveforms of the drive signals COMA, COMB, and COMC in accordance with the operation mode of the liquid ejecting apparatus 1.

As shown in FIG. 11, when the operation mode of the liquid ejecting apparatus 1 is the sleep mode, the operation processing circuit 110 outputs the internal drive control signal iWno including the waveform selection information iwn=[0×0]. When the operation mode of the liquid ejecting apparatus 1 is the standby mode, the operation processing circuit 110 outputs the internal drive control signal iWno including the waveform selection information iwn=[0×1]. When the operation mode of the liquid ejecting apparatus 1 is the start-up mode, the operation processing circuit 110 outputs the internal drive control signal iWno including the waveform selection information iwn=[0×2]. When the operation mode of the liquid ejecting apparatus 1 is the end-down mode, the operation processing circuit 110 outputs the internal drive control signal iWno including the waveform selection information iwn=[0×3]. When the operation mode of the liquid ejecting apparatus 1 is the forced microvibration mode, the operation processing circuit 110 outputs the internal drive control signal iWno including the waveform selection information iwn=[0×4].

The waveform selection information iwn included in the internal drive control signal iWno is not limited to 4-bit information and only needs to have the same number of bits as the waveform selection information wn included in the drive control signal Wno. The same information is assigned to the waveform selection information wn and the waveform selection information iwn corresponding to the same operation mode of the liquid ejecting apparatus 1.

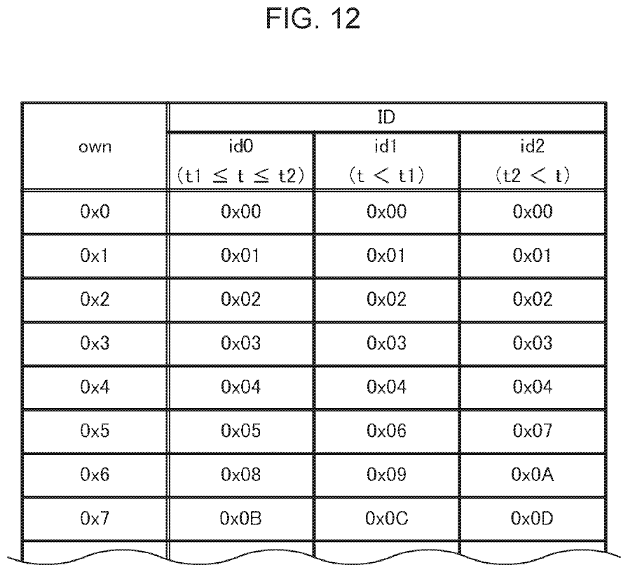

FIG. 12 is a diagram showing an example of the conversion table id included in the conversion table signal ID. As described above, the waveform selection information own included in the drive control signal oWno is converted into the waveform selection information cwv by the conversion table id. While the waveform selection information own described here is 8-bit information, the present disclosure is not limited to this.

Specifically, a conversion table id0 is the conversion table id that is selected when the temperature t of the ejecting module 32 is higher than or equal to a temperature t1 and lower than or equal to a temperature t2, and with which the waveform selection information own is converted into the waveform selection information cwv. The example shown in FIG. 12 shows conversion of the waveform selection information own=[0×0] into the waveform selection information cwv=[0×00], conversion of the waveform selection information own=[0×5] into the waveform selection information cwv=[0×05], and conversion of the waveform selection information own =[0×7] into the waveform selection information cwv=[0×0B] by the conversion table id0. A conversion table id1 is the conversion table id that is selected when the temperature t of the ejecting module 32 is lower than the temperature t1, and with which the waveform selection information own is converted into the waveform selection information cwv. The example shown in FIG. 12 shows conversion of the waveform selection information own=[0×0] into the waveform selection information cwv=[0×00], conversion of the waveform selection information own=[0×5] into the waveform selection information cwv=[0×06], and conversion of the waveform selection information own=[0×7] into the waveform selection information cwv=[0×0C] by the conversion table id1. A conversion table id2 is the conversion table id that is selected when the temperature t of the ejecting module 32 exceeds the temperature t2, and with which the waveform selection information own is converted into the waveform selection information cwv. The example shown in FIG. 12 shows conversion of the waveform selection information own=[0×0] into the waveform selection information cwv=[0×00], conversion of the waveform selection information own=[0×5] into the waveform selection information cwv=[0×07], and conversion of the waveform selection information own=[0×7] into the waveform selection information cwv=[0×0D] by the conversion table id2.

The conversion table id is not limited to the conversion tables id0 to id2 shown in FIG. 12 and may include a plurality of conversion tables id further divided in accordance with detection sensitivity of the temperature t of the ejecting module 32.

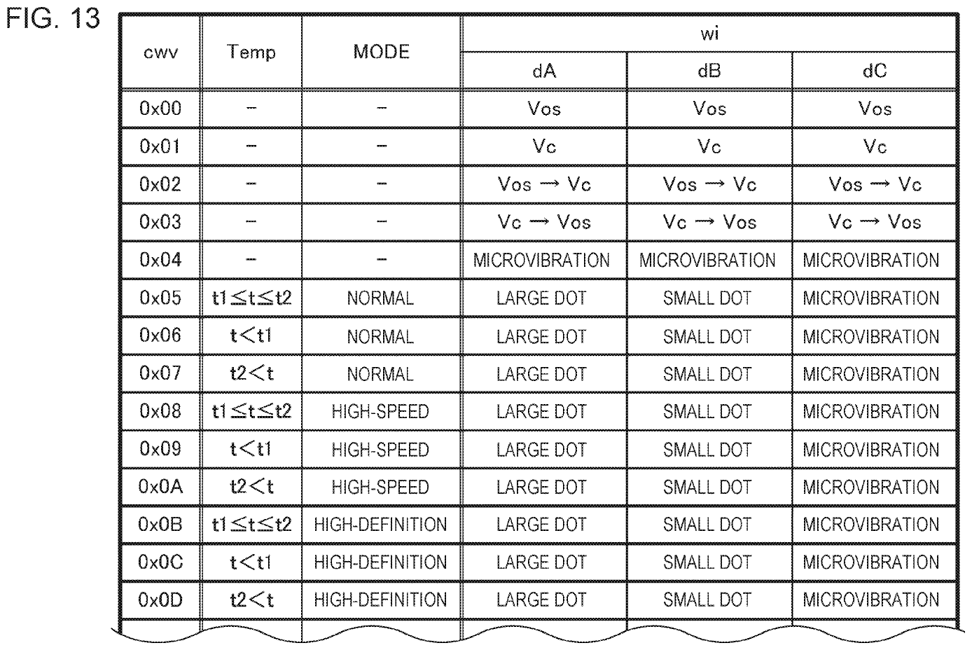

FIG. 13 is a diagram showing an example of the relationship between the waveform selection information cwv and the waveform information wi stored in the storage circuit 230. As described above, the storage circuit 230 stores the waveform information wi corresponding to the waveform selection information cwv.

Specifically, as shown in FIG. 13, the storage circuit 230 stores, as the waveform information wi corresponding to the waveform selection information cwv, information for defining the signal waveform of the drive signal COMA, information for defining the signal waveform of the drive signal COMB, and information for defining the signal waveform of the drive signal COMC in association with the temperature of the ejecting module 32 and the operation mode of the liquid ejecting apparatus 1.

For example, the example shown in FIG. 13 shows the storage circuit 230 storing, as the waveform information wi corresponding to the waveform selection information cwv=[0×00], information for defining the signal waveform of the drive signal COMA having a constant voltage value at the voltage Vos, information for defining the signal waveform of the drive signal COMB having a constant voltage value at the voltage Vos, and information for defining the signal waveform of the drive signal COMC having a constant voltage value at the voltage Vos.

In addition, for example, the example shown in FIG. 13 shows the storage circuit 230 storing, as the waveform information wi corresponding to the waveform selection information cwv=[0×03], information for defining the signal waveform of the drive signal COMA having a voltage value that changes from the voltage Vc to the voltage Vos, information for defining the signal waveform of the drive signal COMB having a voltage value that changes from the voltage Vc to the voltage Vos, and information for defining the signal waveform of the drive signal COMC having a voltage value that changes from the voltage Vc to the voltage Vos.

In addition, for example, the example shown in FIG. 13 shows the storage circuit 230 storing, as the waveform information wi corresponding to the waveform selection information cwv=[0×0C], information for defining the signal waveform of the drive signal COMA having a voltage value that changes to eject the ink corresponding to the large dot LD from the ejecting portion 600, information for defining the signal waveform of the drive signal COMB having a voltage value that changes to eject the ink corresponding to the small dot SD from the ejecting portion 600, and information for defining the signal waveform of the drive signal COMC having a voltage value that changes to cause the ejecting portion 600 to execute microvibration, when the temperature t of the ejecting module 32 is lower than the temperature t1, and the liquid ejecting apparatus 1 operates in the high-definition ejection mode. That is, the storage circuit 230 stores, as the waveform information wi corresponding to the waveform selection information cwv=[0×0C], the waveform information wi for defining the signal waveforms of the drive signals COMA, COMB, and COMC that are suitable when the temperature t of the ejecting module 32 is lower than the temperature t1, and the liquid ejecting apparatus 1 operates in the high-definition ejection mode.

As described above, in the configuration of defining the signal waveforms of the drive signals COMA, COMB, and COMC based on the drive control signal Wno in the liquid ejecting apparatus 1 of the present embodiment, the drive control signal Wno includes the waveform selection information wn as shown in FIG. 10. The internal drive control signal iWno includes the waveform selection information iwn as shown in FIG. 11. The conversion table id includes the conversion tables id0 to id2 selected in accordance with the temperature t of the ejecting module 32 as shown in FIG. 12. The storage circuit 230 stores the waveform information wi corresponding to the waveform selection information cwv as shown in FIG. 13.

In describing the operation of the configuration of controlling the signal waveforms of the drive signals COMA, COMB, and COMC without changing the information included in the drive control signal Wno, the liquid ejecting apparatus 1 operates in the normal ejection mode as the ejection mode, and the temperature of the ejecting module 32 when the liquid ejecting apparatus 1 starts operating is higher than or equal to the temperature t1 and lower than or equal to the temperature t2.

When the liquid ejecting apparatus 1 starts operating, the operation mode of the liquid ejecting apparatus 1 is the boot mode. Accordingly, the control unit 2 outputs the drive control signal Wno including the waveform selection information wn=[0×F]. Here, the transport of the medium P by the control unit 2 is not started. Accordingly, the control unit 2 does not output the timing signal PTS corresponding to the encoder signal ENC.

The operation processing circuit 110 and the switching circuit 120 receive input of the drive control signal Wno including the waveform selection information wn=[0×F] output by the control unit 2. When the operation processing circuit 110 receives input of the drive control signal Wno including the waveform selection information wn=[0×F] before receiving input of the timing signal PTS corresponding to the encoder signal ENC, the operation processing circuit 110 reads the waveform selection information iwn=[0×0] corresponding to the sleep mode from the storage circuit 140 based on a predetermined sequence control. The operation processing circuit 110 outputs the internal drive control signal iWno including the read waveform selection information iwn=[0×0] to the switching circuit 120, generates the internal timing signal iPTS based on the clock signal generated by the clock circuit, not shown, and outputs the internal timing signal iPTS to the switching circuit 120.

The switching circuit 120, before receiving input of the timing signal PTS corresponding to the encoder signal ENC, selects the internal drive control signal iWno as the drive control signal oWno and selects the internal timing signal iPTS as the timing signal oPTS. Accordingly, the conversion circuit 130 receives input of the drive control signal oWno including the waveform selection information own=[0×0] and the timing signal oPTS corresponding to the internal timing signal iPTS.

Here, the temperature of the ejecting module 32 is higher than or equal to the temperature t1 and lower than or equal to the temperature t2. Thus, the operation processing circuit 110 selects the conversion table id0 as the conversion table id. The storage circuit 140 reads the conversion table id0. The storage circuit 140 outputs the conversion table signal ID including the conversion table id0 to the conversion circuit 130. Accordingly, the conversion circuit 130 generates, at a timing corresponding to the timing signal oPTS corresponding to the internal timing signal iPTS, the waveform selection signal cWv including the waveform selection information cwv=[0×00] obtained by converting the waveform selection information own=[0×0] included in the drive control signal oWno based on the conversion table id0, and outputs the waveform selection signal cWv to the waveform selection circuit 220.

The waveform selection circuit 220 reads, from the storage circuit 230 via the operation processing circuit 210, information for defining the signal waveform of the drive signal COMA having a constant voltage value at the voltage Vos, information for defining the signal waveform of the drive signal COMB having a constant voltage value at the voltage Vos, and information for defining the signal waveform of the drive signal COMC having a constant voltage value at the voltage Vos, as the waveform information wi corresponding to the waveform selection information cwv=[0×00]. The waveform selection circuit 220 outputs, in accordance with the read waveform information wi, the base drive signal dA for defining the signal waveform of the drive signal COMA having a constant voltage value at the voltage Vos, the base drive signal dB for defining the signal waveform of the drive signal COMB having a constant voltage value at the voltage Vos, and the base drive signal dC for defining the signal waveform of the drive signal COMC having a constant voltage value at the voltage Vos. Accordingly, the drive signal output circuit 50 outputs the drive signals COMA, COMB, and COMC having constant voltage values at the voltage Vos.

Then, the operation processing circuit 110 reads the waveform selection information iwn=[0×2] corresponding to the start-up mode from the storage circuit 140 by executing a predetermined sequence control at a timing corresponding to the internal timing signal iPTS. The operation processing circuit 110 outputs the internal drive control signal iWno including the read waveform selection information iwn=[0×2] to the switching circuit 120, generates the internal timing signal iPTS based on the clock signal generated by the clock circuit, not shown, and outputs the internal timing signal iPTS to the switching circuit 120.

The timing signal PTS corresponding to the encoder signal ENC is not input into the switching circuit 120. Thus, the switching circuit 120 selects the internal drive control signal iWno as the drive control signal oWno and selects the internal timing signal iPTS as the timing signal oPTS. Accordingly, the conversion circuit 130 receives input of the drive control signal oWno including the waveform selection information own=[0×2] and the timing signal oPTS corresponding to the internal timing signal iPTS.

The conversion circuit 130 generates, at a timing corresponding to the timing signal oPTS corresponding to the internal timing signal iPTS, the waveform selection signal cWv including the waveform selection information cwv=[0×02] obtained by converting the waveform selection information own=[0×2] included in the drive control signal oWno into the waveform selection information cwv=[0×02] based on the conversion table id0, and outputs the waveform selection signal cWv to the waveform selection circuit 220.

The waveform selection circuit 220 reads, from the storage circuit 230 via the operation processing circuit 210, information for defining the signal waveforms of each of the drive signals COMA, COMB, and COMC having voltage values that change from the voltage Vos to the voltage Vc, as the waveform information wi corresponding to the waveform selection information cwv=[0×02]. The waveform selection circuit 220 outputs, in accordance with the read waveform information wi, the base drive signals dA, dB, and dC for defining the signal waveforms of the drive signals COMA, COMB, and COMC having voltage values that change from the voltage Vos to the voltage Vc. Accordingly, the drive signal output circuit 50 outputs the drive signals COMA, COMB, and COMC having voltage values that change from the voltage Vos to the voltage Vc.

Then, the operation processing circuit 110 reads the waveform selection information iwn=[0×1] corresponding to the standby mode from the storage circuit 140 by executing a predetermined sequence control at a timing corresponding to the internal timing signal iPTS. The operation processing circuit 110 outputs the internal drive control signal iWno including the read waveform selection information iwn=[0×1] to the switching circuit 120, generates the internal timing signal iPTS based on the clock signal generated by the clock circuit, not shown, and outputs the internal timing signal iPTS to the switching circuit 120.

The timing signal PTS corresponding to the encoder signal ENC is not input into the switching circuit 120. Thus, the switching circuit 120 selects the internal drive control signal iWno as the drive control signal oWno and selects the internal timing signal iPTS as the timing signal oPTS. Accordingly, the conversion circuit 130 receives input of the drive control signal oWno including the waveform selection information own=[0×1] and the timing signal oPTS corresponding to the internal timing signal iPTS.

The conversion circuit 130 generates, at a timing corresponding to the timing signal oPTS corresponding to the internal timing signal iPTS, the waveform selection signal cWv including the waveform selection information cwv=[0×01] obtained by converting the waveform selection information own=[0×1] included in the drive control signal oWno into the waveform selection information cwv=[0×01] based on the conversion table id0, and outputs the waveform selection signal cWv to the waveform selection circuit 220.

The waveform selection circuit 220 reads, from the storage circuit 230 via the operation processing circuit 210, information for defining the signal waveforms of each of the drive signals COMA, COMB, and COMC having constant voltage values at the voltage Vc, as the waveform information wi corresponding to the waveform selection information cwv=[0×01]. The waveform selection circuit 220 outputs, in accordance with the read waveform information wi, the base drive signals dA, dB, and dC for defining the signal waveforms of the drive signals COMA, COMB, and COMC having constant voltage values at the voltage Vc. Accordingly, the drive signal output circuit 50 outputs the drive signals COMA, COMB, and COMC having constant voltage values at the voltage Vc.

Then, the operation processing circuit 110 reads the waveform selection information iwn=[0×4] corresponding to the forced microvibration mode from the storage circuit 140 by executing a predetermined sequence control at a timing corresponding to the internal timing signal iPTS. The operation processing circuit 110 outputs the internal drive control signal iWno including the read waveform selection information iwn=[0×4] to the switching circuit 120, generates the internal timing signal iPTS based on the clock signal generated by the clock circuit, not shown, and outputs the internal timing signal iPTS to the switching circuit 120.

The timing signal PTS corresponding to the encoder signal ENC is not input into the switching circuit 120. Thus, the switching circuit 120 selects the internal drive control signal iWno as the drive control signal oWno and selects the internal timing signal iPTS as the timing signal oPTS. Accordingly, the conversion circuit 130 receives input of the drive control signal oWno including the waveform selection information own=[0×4] and the timing signal oPTS corresponding to the internal timing signal iPTS.

The conversion circuit 130 generates, at a timing corresponding to the timing signal oPTS corresponding to the internal timing signal iPTS, the waveform selection signal cWv including the waveform selection information cwv=[0×04] obtained by converting the waveform selection information own=[0×4] included in the drive control signal oWno into the waveform selection information cwv=[0×04] based on the conversion table id0, and outputs the waveform selection signal cWv to the waveform selection circuit 220.

The waveform selection circuit 220 reads, from the storage circuit 230 via the operation processing circuit 210, information for defining the signal waveforms of each of the drive signals COMA, COMB, and COMC for causing the ejecting portion 600 to execute microvibration, as the waveform information wi corresponding to the waveform selection information cwv=[0×04]. The waveform selection circuit 220 outputs, in accordance with the read waveform information wi, the base drive signals dA, dB, and dC for defining the signal waveforms of the drive signals COMA, COMB, and COMC for causing the ejecting portion 600 to execute microvibration. Accordingly, the drive signal output circuit 50 outputs the drive signals COMA, COMB, and COMC corresponding to microvibration.

Then, the control unit 2 starts transporting the medium P. Accordingly, the operation processing circuit 110 and the switching circuit 120 receive input of the timing signal PTS corresponding to the encoder signal ENC. The control unit 2 outputs the drive control signal Wno including the waveform selection information wn=[0×4] corresponding to the forced microvibration mode.

When the operation processing circuit 110 receives input of the timing signal PTS corresponding to the encoder signal ENC, the operation processing circuit 110 stops outputting the internal timing signal iPTS and the internal drive control signal iWno. In addition, the switching circuit 120, after receiving input of the timing signal PTS corresponding to the encoder signal ENC, selects the drive control signal Wno as the drive control signal oWno and selects the timing signal PTS as the timing signal oPTS after a predetermined period elapses. Accordingly, the conversion circuit 130 receives input of the drive control signal oWno including the waveform selection information own=[0×4] and the timing signal oPTS corresponding to the timing signal PTS.

The conversion circuit 130 generates, at a timing corresponding to the timing signal oPTS corresponding to the timing signal PTS, the waveform selection signal cWv including the waveform selection information cwv=[0×04] obtained by converting the waveform selection information own=[0×4] included in the drive control signal oWno into the waveform selection information cwv=[0×04] based on the conversion table id0, and outputs the waveform selection signal cWv to the waveform selection circuit 220.

The waveform selection circuit 220 reads, from the storage circuit 230 via the operation processing circuit 210, information for defining the signal waveforms of each of the drive signals COMA, COMB, and COMC for causing the ejecting portion 600 to execute microvibration, as the waveform information wi corresponding to the waveform selection information cwv=[0×04]. The waveform selection circuit 220 outputs, in accordance with the read waveform information wi, the base drive signals dA, dB, and dC for defining the signal waveforms of the drive signals COMA, COMB, and COMC for causing the ejecting portion 600 to execute microvibration. Accordingly, the drive signal output circuit 50 continues outputting the drive signals COMA, COMB, and COMC corresponding to microvibration.

Then, the operation mode of the liquid ejecting apparatus 1 transitions to the normal ejection mode, which is the ejection mode in which the ink can be ejected to the medium P. Accordingly, the control unit 2 outputs the drive control signal Wno including the waveform selection information wn=[0×5] corresponding to the normal ejection mode.

The timing signal PTS corresponding to the encoder signal ENC is input into the switching circuit 120. Thus, the switching circuit 120 selects the drive control signal Wno as the drive control signal oWno and selects the timing signal PTS as the timing signal oPTS. Accordingly, the conversion circuit 130 receives input of the drive control signal oWno including the waveform selection information own=[0×5] and the timing signal oPTS corresponding to the timing signal PTS.

The conversion circuit 130 generates, at a timing corresponding to the timing signal oPTS corresponding to the timing signal PTS, the waveform selection signal cWv including the waveform selection information cwv=[0×05] obtained by converting the waveform selection information own=[0×5] included in the drive control signal oWno into the waveform selection information cwv=[0×05] based on the conversion table id0, and outputs the waveform selection signal cWv to the waveform selection circuit 220.

The waveform selection circuit 220 reads, from the storage circuit 230 via the operation processing circuit 210, as the waveform information wi corresponding to the waveform selection information cwv=[0×05], information for defining the signal waveform of the drive signal COMA having a voltage value that changes to eject the ink corresponding to the large dot LD from the ejecting portion 600, information for defining the signal waveform of the drive signal COMB having a voltage value that changes to eject the ink corresponding to the small dot SD from the ejecting portion 600, and information for defining the signal waveform of the drive signal COMC having a voltage value that changes to cause the ejecting portion 600 to execute microvibration, when the temperature t of the ejecting module 32 is higher than or equal to the temperature t1 and lower than or equal to the temperature t2, and the operation mode of the liquid ejecting apparatus 1 is the normal ejection mode. The waveform selection circuit 220 outputs, in accordance with the read waveform information wi, the base drive signals dA, dB, and dC for defining the signal waveforms of the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration, when the temperature t of the ejecting module 32 is higher than or equal to the temperature t1 and lower than or equal to the temperature t2. Accordingly, the drive signal output circuit 50 outputs the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration, when the temperature t of the ejecting module 32 is higher than or equal to the temperature t1 and lower than or equal to the temperature t2. In other words, the drive signal output circuit 50 outputs the drive signals COMA, COMB, and COMC having signal waveforms suitable for executing the normal ejection mode when the temperature t of the ejecting module 32 is higher than or equal to the temperature t1 and lower than or equal to the temperature t2.

The liquid ejecting apparatus 1 continues the normal ejection mode during a period in which an image is formed on the medium P. When the drive signal selection circuit 300 generates heat, the temperature t of the ejecting module 32 increases because of the generated heat. When the temperature t of the ejecting module 32 exceeds the temperature t2 because of a rise in the temperature, the operation processing circuit 110 selects the conversion table id2 as the conversion table id based on the input state detection signal rSs, and reads the conversion table id2 from the storage circuit 140. The operation processing circuit 110 generates the conversion table signal ID including the conversion table id2, and outputs the conversion table signal ID to the conversion circuit 130. That is, the conversion table id held by the conversion circuit 130 is updated.

The conversion circuit 130 receives input of the waveform selection information own=[0×5] included in the drive control signal oWno at a timing corresponding to the timing signal oPTS corresponding to the timing signal PTS. The conversion circuit 130 generates the waveform selection signal cWv including the waveform selection information cwv=[0×07] obtained by converting the waveform selection information own=[0×5] included in the input drive control signal oWno into the waveform selection information cwv=[0×07] based on the conversion table id2, and outputs the waveform selection signal cWv to the waveform selection circuit 220.

The waveform selection circuit 220 reads, from the storage circuit 230 via the operation processing circuit 210, as the waveform information wi corresponding to the waveform selection information cwv=[0×07], information for defining the signal waveform of the drive signal COMA having a voltage value that changes to eject the ink corresponding to the large dot LD from the ejecting portion 600, information for defining the signal waveform of the drive signal COMB having a voltage value that changes to eject the ink corresponding to the small dot SD from the ejecting portion 600, and information for defining the signal waveform of the drive signal COMC having a voltage value that changes to cause the ejecting portion 600 to execute microvibration, when the temperature t of the ejecting module 32 exceeds the temperature t2, and the operation mode of the liquid ejecting apparatus 1 is the normal ejection mode. The waveform selection circuit 220 outputs, in accordance with the read waveform information wi, the base drive signals dA, dB, and dC for defining the signal waveforms of the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration, when the temperature t of the ejecting module 32 exceeds the temperature t2. Accordingly, the drive signal output circuit 50 outputs the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration, when the temperature t of the ejecting module 32 exceeds the temperature t2. That is, the signal waveforms of the drive signals COMA, COMB, and COMC output by the drive signal output circuit 50 are controlled to change to the optimal waveform shapes corresponding to the temperature t of the ejecting module 32, which is the state of the ejecting module 32, without changing the drive control signal Wno input into the head unit 5.

In the above description, an example of an operation when the temperature t of the ejecting module 32 exceeds the temperature t2 is shown. However, even when the temperature t of the ejecting module 32 is lower than the temperature t1, the conversion table id is updated in accordance with the temperature t of the ejecting module 32. Accordingly, the signal waveforms of the drive signals COMA, COMB, and COMC output by the drive signal output circuit 50 can be controlled to change to the optimal waveform shapes corresponding to the temperature t of the ejecting module 32, which is the state of the ejecting module 32, without changing the drive control signal Wno input into the head unit 5.

As described above, in the liquid ejecting apparatus 1 and the head unit 5 of the first embodiment, the relay unit 10 and the head drive module 20 that control an operation of the liquid ejecting module 30 include the storage circuit 230 that stores a plurality of pieces of the waveform information wi, the waveform selection circuit 220 that selects, in accordance with one of the plurality of conversion tables id and the drive control signal Wno, one of the plurality of pieces of waveform information wi as the waveform information wi corresponding to the signal waveforms of the drive signals COMA, COMB, and COMC, the drive signal output circuit 50 that outputs the drive signals COMA, COMB, and COMC corresponding to the waveform information wi selected by the waveform selection circuit 220, and the detection circuit 150 that detects the state of the ejecting module 32 which is a state of at least one of the relay unit 10, the head drive module 20, or the liquid ejecting module 30.

The waveform selection circuit 220 selects, in accordance with the waveform selection information wn=[0×5] as the drive control signal Wno and the conversion table id0 among the plurality of conversion tables id, the waveform information wi suitable for ejecting the ink in the normal ejection mode when the temperature t of the ejecting module 32 is higher than or equal to the temperature t1 and lower than or equal to the temperature t2, as the waveform information wi corresponding to the signal waveforms of the drive signals COMA, COMB, and COMC. In addition, the waveform selection circuit 220 selects, in accordance with the waveform selection information wn=[0×5] as the drive control signal Wno and the conversion table id2 among the plurality of conversion tables id, the waveform information wi suitable for ejecting the ink in the normal ejection mode when the temperature t of the ejecting module 32 exceeds the temperature t2, as the waveform information wi corresponding to the signal waveforms of the drive signals COMA, COMB, and COMC. That is, the waveform selection circuit 220 selects the waveform information wi corresponding to the signal waveforms of the drive signals COMA, COMB, and COMC, in accordance with one of the plurality of conversion tables id selected in accordance with the temperature t of the ejecting module 32, which is the detection result of the state of the ejecting module 32 in the detection circuit 150.

The waveform information wi corresponding to the signal waveforms of the drive signals COMA, COMB, and COMC selected using the conversion table id0 and the waveform information wi corresponding to the signal waveforms of the drive signals COMA, COMB, and COMC selected using the conversion table id2 in accordance with the same the waveform selection information wn as the drive control signal Wno may be the same information. That is, as shown in the present embodiment, the waveform selection circuit 220 may select, in accordance with the waveform selection information wn=[0×4] as the drive control signal Wno and the conversion table id0, the waveform information wi of the signal waveform having a voltage value that changes to cause the ejecting portion 600 to execute microvibration, as the waveform information wi corresponding to the signal waveforms of the drive signals COMA, COMB, and COMC, and select, in accordance with the waveform selection information wn=[0×4] as the drive control signal Wno and the conversion table id2, the waveform information wi of the signal waveform having a voltage value that changes to cause the ejecting portion 600 to execute microvibration, as the waveform information wi corresponding to the signal waveforms of the drive signals COMA, COMB, and COMC. Accordingly, versatility of the conversion table id can be increased.

The ejecting module 32 is an example of a printhead. A configuration consisting of the relay unit 10 and the head drive module 20 is an example of a head controller. The storage circuit 230 is an example of a storage circuit. The waveform selection circuit 220 is an example of a waveform selection circuit. The detection circuit 150 is an example of a detection circuit. The drive signal output circuit 50 including the drive circuits 52a, 52b, and 52c is an example of a drive signal output circuit. The drive signals COMA, COMB, and COMC are examples of a drive signal. The drive control signal Wno is an example of a drive control signal. The waveform selection information wn=[0×5] in the waveform selection information wn included in the drive control signal Wno is an example of first drive information. The waveform selection information wn=[0×4] is an example of second drive information. The plurality of pieces of waveform information wi are an example of a plurality of pieces of waveform information. The waveform information wi corresponding to the signal waveforms of the drive signals COMA, COMB, and COMC selected by the waveform selection circuit 220 among the plurality of pieces of waveform information wi is an example of drive waveform information. The waveform information wi, selected as the waveform information wi corresponding to the signal waveforms of the drive signals COMA, COMB, and COMC, suitable for ejecting the ink in the normal ejection mode when the temperature t of the ejecting module 32 is higher than or equal to the temperature t1 and lower than or equal to the temperature t2 is an example of first drive waveform information. The waveform information wi, selected as the waveform information wi corresponding to the signal waveforms of the drive signals COMA, COMB, and COMC, suitable for ejecting the ink in the normal ejection mode when the temperature t of the ejecting module 32 exceeds the temperature t2 is an example of second drive waveform information. The waveform information wi, selected as the waveform information wi corresponding to the signal waveforms of the drive signals COMA, COMB, and COMC, of the signal waveform having a voltage value that changes to cause the ejecting portion 600 to execute microvibration is an example of third drive waveform information. The plurality of conversion table ids are an example of a plurality of waveform information tables. The conversion table id0 is an example of a first waveform information table. The conversion table id2 is an example of a second waveform information table.

### 1.4 Operations and Effects

As described above, in the liquid ejecting apparatus 1 and the head unit 5 of the present embodiment, the relay unit 10 and the head drive module 20 that control the operation of the liquid ejecting module 30 include the storage circuit 230 that stores the plurality of pieces of waveform information wi, the waveform selection circuit 220 that selects, in accordance with one of the plurality of conversion tables id and the drive control signal Wno, one of the plurality of pieces of waveform information wi as the waveform information wi corresponding to the signal waveforms of the drive signals COMA, COMB, and COMC, the drive signal output circuit 50 that outputs the drive signals COMA, COMB, and COMC corresponding to the waveform information wi selected by the waveform selection circuit 220, and the detection circuit 150 that detects the state of the liquid ejecting module 30 which is a state of at least one of the relay unit 10, the head drive module 20, or the liquid ejecting module 30. The waveform selection circuit 220 selects, in accordance with the waveform selection information wn=[0×5] as the drive control signal Wno and the conversion table id0 among the plurality of conversion tables id, the waveform information wi suitable for ejecting the ink in the normal ejection mode when the temperature t of the ejecting module 32 is higher than or equal to the temperature t1 and lower than or equal to the temperature t2, as the waveform information wi corresponding to the signal waveforms of the drive signals COMA, COMB, and COMC. The waveform selection circuit 220 selects, in accordance with the waveform selection information wn=[0×5] as the drive control signal Wno and the conversion table id2 among the plurality of conversion tables id, the waveform information wi suitable for ejecting the ink in the normal ejection mode when the temperature t of the ejecting module 32 exceeds the temperature t2, as the waveform information wi corresponding to the signal waveforms of the drive signals COMA, COMB, and COMC.

Accordingly, even when the same waveform selection information wn of [0×5] is input as the drive control signal Wno, the drive signal output circuit 50 can output the drive signals COMA, COMB, and COMC having different signal waveforms without passing through the control unit 2. Accordingly, by selecting the optimal conversion table id in accordance with, for example, the temperature of the ink stored in the ejecting module 32, which is the state of the ejecting module 32, or the operation mode of the liquid ejecting apparatus 1 based on the detection result of the detection circuit 150, the drive signals COMA, COMB, and COMC having optimal waveform shapes corresponding to, for example, the temperature of the ink stored in the ejecting module 32, which is the state of the ejecting module 32, or the operation mode of the liquid ejecting apparatus 1 can be output independently of the control of the control unit 2.

The control of selection and output of the drive signals COMA, COMB, and COMC having optimal waveform shapes corresponding to, for example, the temperature of the ink stored in the ejecting module 32, which is the state of the ejecting module 32, or the operation mode of the liquid ejecting apparatus 1 can be completed in the head unit 5. Thus, even when the liquid ejecting apparatus 1 includes a plurality of head units 5, a load required for processing in the control unit 2 is less likely to increase. Accordingly, even when the number of head units 5 coupled to the control unit 2 increases, stability of the operation of the liquid ejecting apparatus 1 improves.

### 2. Second Embodiment

Next, the liquid ejecting apparatus 1 and the head unit 5 of a second embodiment will be described. The liquid ejecting apparatus 1 of the second embodiment is different from the liquid ejecting apparatus 1 and the head unit 5 of the first embodiment in that the plurality of pieces of waveform information wi stored in the storage circuit 230 and the plurality of conversion tables id stored in the storage circuit 140 are rewritable.

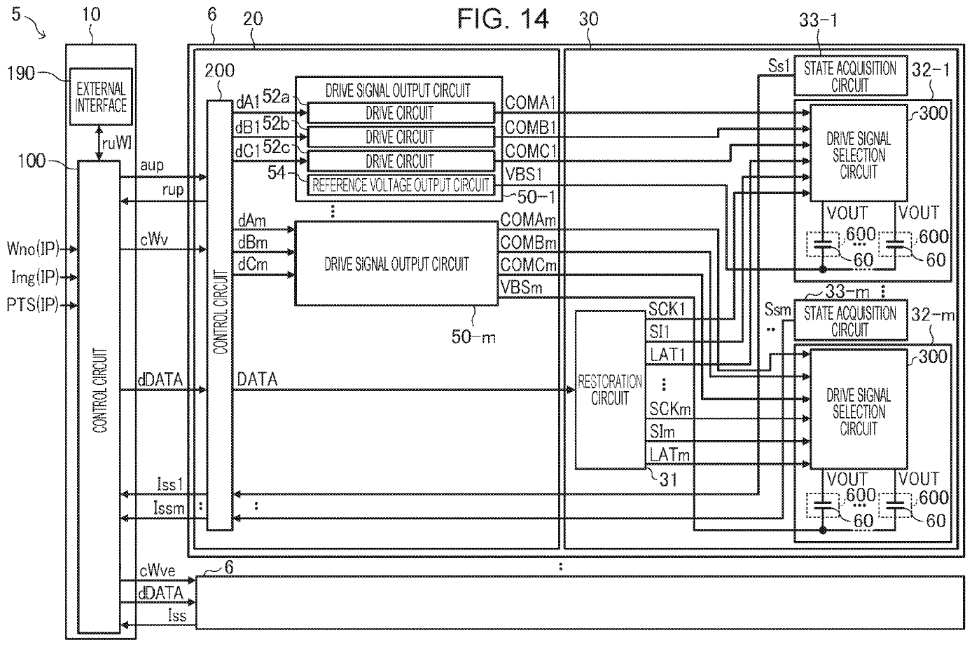

FIG. 14 is a diagram showing a schematic configuration of the head unit 5 of the second embodiment. As shown in FIG. 14, the head unit 5 of the second embodiment includes an external interface 190 through which the relay unit 10 can connect to and communicate with an outside of the liquid ejecting apparatus 1.

The external interface 190 may be a connector or a wireless communication module that can communicate with a server, not shown, via a network line, or may be a USB connector to which an external hard disk or the like can connect.

In the liquid ejecting apparatus 1 and the head unit 5 of the second embodiment, the control circuit 100 acquires new waveform information wi and a new conversion table id via the external interface 190 at a predetermined timing or based on a request from the control circuit 200. The control circuit 100 stores the acquired new waveform information wi and the acquired new conversion table id in the corresponding storage circuits 140 and 230. Accordingly, at least one of the plurality of conversion tables id stored in the storage circuit 140 and at least one of the plurality of pieces of waveform information wi stored in the storage circuit 230 can be updated to the new waveform information wi and the new conversion table id acquired via the external interface 190. Accordingly, in the liquid ejecting apparatus 1 and the head unit 5 of the second embodiment, the drive signals COMA, COMB, and COMC having more optimal waveform shapes can be selected and output in accordance with a state of the head unit 5 including the ejecting module 32.

As described with respect to the liquid ejecting apparatus 1 of the first embodiment, the waveform information wi corresponding to the signal waveforms of the drive signals COMA, COMB, and COMC output by the drive signal output circuit 50 is defined by the conversion table id. Thus, by understanding contents of the conversion table id, the waveform information wi that is not selected as the signal waveforms of the drive signals COMA, COMB, and COMC output by the drive signal output circuit 50 during a period in which the liquid ejecting apparatus 1 ejects the ink to the medium P can be understood.

The control circuit 100 can update the waveform information wi that is not selected as the signal waveforms of the drive signals COMA, COMB, and COMC output by the drive signal output circuit 50, to the new waveform information wi via the external interface 190 even during the period in which the liquid ejecting apparatus 1 ejects the ink to the medium P. Accordingly, in the liquid ejecting apparatus 1 and the head unit 5 of the second embodiment, the number of pieces of the waveform information wi that can be selected as the signal waveforms of the drive signals COMA, COMB, and COMC increases, and accuracy of the output drive signals COMA, COMB, and COMC can further improve, in addition to the above operations and effects of the first embodiment.

The external interface 190 is an example of a communication circuit, and the new waveform information wi acquired via the external interface 190 is an example of acquired waveform information.

### 3. Modification Example

In the liquid ejecting apparatus 1 and the head unit 5 of the first embodiment described above, the state acquisition circuits 33-1 to 33-m acquire the temperatures t of the ejecting modules 32-1 to 32-m, and the detection circuit 150 detects the temperatures t of the ejecting modules 32-1 to 32-m based on the temperatures t of the ejecting modules 32-1 to 32-m acquired by the state acquisition circuits 33-1 to 33-m. Alternatively, the detection circuit 150 may detect viscosity of the ink stored in the ejecting modules 32-1 to 32-m. In this case, the operation processing circuit 110 may select the conversion table id in accordance with the viscosity of the ink detected by the detection circuit 150.

Specifically, the state acquisition circuits 33-1 to 33-m include a residual vibration detection circuit that detects residual vibration generated after the ejecting portions 600 included in the corresponding ejecting modules 32-1 to 32-m are driven, and acquire a phase, a cycle, and an amplitude of the residual vibration detected by the residual vibration detection circuit. The detection circuit 150 detects the viscosity of the ink stored in the ejecting modules 32-1 to 32-m based on the phase, the cycle, and the amplitude of the residual vibration acquired by the state acquisition circuits 33-1 to 33-m. The operation processing circuit 110 may select the conversion table id in accordance with the viscosity of the ink detected by the detection circuit 150.

The detection circuit 150 may detect the type of the ink stored in the ejecting modules 32-1 to 32-m. In this case, the operation processing circuit 110 may select the conversion table id in accordance with the type of the ink detected by the detection circuit 150.

Specifically, the state acquisition circuits 33-1 to 33-m read a microchip provided in the liquid containers 3 storing the ink, and the detection circuit 150 detects the type of the ink stored in the ejecting modules 32-1 to 32-m based on information on the microchip read by the state acquisition circuits 33-1 to 33-m. The operation processing circuit 110 may select the conversion table id in accordance with the type of the ink detected by the detection circuit 150. Information on the type of the ink stored in the liquid container 3 may be acquired by, for example, input of information by a user.

Such a configuration can also achieve the same operations and effects as the liquid ejecting apparatus 1 and the head unit 5 of the first embodiment and the second embodiment described above.

While the embodiments and the modification example are described above, the present disclosure is not limited to such embodiments and can be embodied with various aspects without departing from its concept. For example, the above embodiments can be combined as appropriate.

The present disclosure includes substantially the same configurations (for example, configurations having the same functions, methods, and results, or configurations having the same objects and effects) as the configurations described in the embodiments. The present disclosure includes configurations obtained by replacing non-essential parts of the configurations described in the embodiments. The present disclosure also includes configurations that achieve the same operations and effects or configurations that can achieve the same objects as the configurations described in the embodiments. The present disclosure also includes configurations obtained by adding a well-known technology to the configurations described in the embodiments.

The following contents are derived from the above embodiments.

According to an aspect, a head unit includes a printhead that ejects a liquid in accordance with a drive signal, and a head controller that receives input of a drive control signal and controls the ejection of the liquid from the printhead, in which the head controller includes a storage circuit that stores a plurality of pieces of waveform information, a waveform selection circuit that selects one of the plurality of pieces of waveform information as drive waveform information in accordance with one of a plurality of waveform information tables and the drive control signal, a drive signal output circuit that outputs the drive signal corresponding to the drive waveform information selected by the waveform selection circuit, and a detection circuit that detects a state of at least one of the printhead or the head controller, and the waveform selection circuit selects first drive waveform information as the drive waveform information in accordance with first drive information as the drive control signal and a first waveform information table among the plurality of waveform information tables, and selects second drive waveform information different from the first drive waveform information as the drive waveform information in accordance with the first drive information and a second waveform information table among the plurality of waveform information tables.

According to the head unit, the waveform selection circuit that selects one of the plurality of pieces of waveform information as the drive waveform information in accordance with one of the plurality of waveform information tables and the drive control signal selects the first drive waveform information as the drive waveform information in accordance with the first drive information as the drive control signal and the first waveform information table among the plurality of waveform information tables, and selects the second drive waveform information different from the first drive waveform information as the drive waveform information in accordance with the first drive information and the second waveform information table among the plurality of waveform information tables. Accordingly, the waveform selection circuit can control a waveform of the drive signal output by the drive signal output circuit in accordance with the state of the head unit independently of a control of an upstream configuration that controls an operation of the head unit and outputs the drive control signal. Accordingly, versatility of the head unit can be increased, and even in an apparatus including a plurality of the head units, a control load of the upstream configuration that controls the operation and outputs the drive control signal can be reduced.

In the aspect of the head unit, the waveform selection circuit may select the drive waveform information in accordance with one of the plurality of waveform information tables selected in accordance with a detection result of the detection circuit.

According to the head unit, an optimal waveform of the drive signal corresponding to the state of the printhead can be selected independently of the control of the upstream configuration that controls the operation of the head unit and outputs the drive control signal.

In the aspect of the head unit, the detection circuit may detect a temperature of the printhead.

According to the head unit, an optimal waveform of the drive signal corresponding to the temperature of the printhead can be selected independently of the control of the upstream configuration that controls the operation of the head unit and outputs the drive control signal.

In the aspect of the head unit, the detection circuit may detect viscosity of an ink stored in the printhead.

According to the head unit, an optimal waveform of the drive signal corresponding to the viscosity of the ink stored in the printhead can be selected independently of the control of the upstream configuration that controls the operation of the head unit and outputs the drive control signal.

In the aspect of the head unit, the waveform selection circuit may select one of the plurality of waveform information tables in accordance with a type of an ink stored in the printhead.

According to the head unit, an optimal waveform of the drive signal corresponding to the type of the ink stored in the printhead can be selected independently of the control of the upstream configuration that controls the operation of the head unit and outputs the drive control signal.

In the aspect of the head unit, the waveform selection circuit may select third drive waveform information as the drive waveform information in accordance with second drive information as the drive control signal and the first waveform information table, and select the third drive waveform information as the drive waveform information in accordance with the second drive information and the second waveform information table.

In the aspect of the head unit, the plurality of pieces of waveform information may be rewritable.

According to the head unit, the number of signal waveforms that can be selected as the waveform of the drive signal output by the drive signal output circuit increases independently of the control of the upstream configuration that controls the operation of the head unit and outputs the drive control signal. Thus, the versatility of the head unit can be further increased.

The head unit of the aspect may further include a communication circuit configured to communicate with a server, in which at least one of the plurality of pieces of waveform information is rewritten with acquired waveform information acquired from the server via the communication circuit in accordance with a detection result of the detection circuit.

According to the head unit, the number of signal waveforms that can be selected as the waveform of the drive signal output by the drive signal output circuit increases independently of the control of the upstream configuration that controls the operation of the head unit and outputs the drive control signal. Thus, the versatility of the head unit can be further increased.

According to another aspect, a liquid ejecting apparatus includes a head unit including a printhead that ejects a liquid in accordance with a drive signal, and a head controller that receives input of a drive control signal and controls the ejection of the liquid from the printhead, and a control unit that controls the head unit, in which the head controller includes a storage circuit that stores a plurality of pieces of waveform information, a waveform selection circuit that selects one of the plurality of pieces of waveform information as drive waveform information in accordance with one of a plurality of waveform information tables and the drive control signal, a drive signal output circuit that outputs the drive signal corresponding to the drive waveform information selected by the waveform selection circuit, and a detection circuit that detects a state of at least one of the printhead or the head controller, and the waveform selection circuit selects first drive waveform information as the drive waveform information in accordance with first drive information as the drive control signal and a first waveform information table among the plurality of waveform information tables, and selects second drive waveform information different from the first drive waveform information as the drive waveform information in accordance with the first drive information and a second waveform information table among the plurality of waveform information tables.

According to the liquid ejecting apparatus, the waveform selection circuit that selects one of the plurality of pieces of waveform information as the drive waveform information in accordance with one of the plurality of waveform information tables and the drive control signal selects the first drive waveform information as the drive waveform information in accordance with the first drive information as the drive control signal and the first waveform information table among the plurality of waveform information tables, and selects the second drive waveform information different from the first drive waveform information as the drive waveform information in accordance with the first drive information and the second waveform information table among the plurality of waveform information tables. Accordingly, the waveform selection circuit can control a waveform of the drive signal output by the drive signal output circuit in accordance with the state of the head unit independently of a control of the control unit. Accordingly, versatility of the head unit can be increased, and even when a plurality of the head units are provided, a control load of the control unit that controls the operation and outputs the drive control signal can be reduced.

In the aspect of the liquid ejecting apparatus, the waveform selection circuit may select the drive waveform information in accordance with one of the plurality of waveform information tables selected in accordance with a detection result of the detection circuit.

According to the liquid ejecting apparatus, an optimal waveform of the drive signal corresponding to the state of the head unit can be selected independently of the control of the control unit.

In the aspect of the liquid ejecting apparatus, the detection circuit may detect a temperature of the printhead.

According to the liquid ejecting apparatus, an optimal waveform of the drive signal corresponding to the temperature of the printhead can be selected independently of the control of the control unit.

In the aspect of the liquid ejecting apparatus, the detection circuit may detect viscosity of an ink stored in the printhead.

According to the liquid ejecting apparatus, an optimal waveform of the drive signal corresponding to the viscosity of the ink stored in the printhead can be selected independently of the control of the control unit.

In the aspect of the liquid ejecting apparatus, the waveform selection circuit may select one of the plurality of waveform information tables in accordance with a type of an ink stored in the printhead.

According to the liquid ejecting apparatus, an optimal waveform of the drive signal corresponding to the type of the ink stored in the printhead can be selected independently of the control of the control unit.

In the aspect of the liquid ejecting apparatus, the waveform selection circuit may select third drive waveform information as the drive waveform information in accordance with second drive information as the drive control signal and the first waveform information table, and select the third drive waveform information as the drive waveform information in accordance with the second drive information and the second waveform information table.

In the aspect of the liquid ejecting apparatus, the plurality of pieces of waveform information may be rewritable.

According to the liquid ejecting apparatus, the number of signal waveforms that can be selected as the waveform of the drive signal output by the drive signal output circuit increases. Thus, the versatility of the head unit can be further increased.

The liquid ejecting apparatus of the aspect may further include a communication circuit configured to communicate with a server, in which at least one of the plurality of pieces of waveform information is rewritten with acquired waveform information acquired from the server via the communication circuit in accordance with a detection result of the detection circuit.

According to the liquid ejecting apparatus, the number of signal waveforms that can be selected as the waveform of the drive signal output by the drive signal output circuit increases. Thus, the versatility of the head unit can be further increased.

In the aspect of the liquid ejecting apparatus, the printhead may be a line head that extends in a width direction of a medium.

According to the liquid ejecting apparatus, even when a plurality of the head units are provided, the control load of the control unit that controls the operation and outputs the drive control signal can be reduced. Thus, even when the printhead is a line head that extends in the width direction of the medium, a stable operation can be implemented.

What is claimed is:

1. A head unit comprising:
a printhead that ejects a liquid in accordance with a drive signal; and
a head controller that receives input of a drive control signal and controls the ejection of the liquid from the printhead, wherein
the head controller includes
a storage circuit that stores a plurality of pieces of waveform information,
a waveform selection circuit that selects one of the plurality of pieces of waveform information as drive waveform information in accordance with one of a plurality of waveform information tables and the drive control signal,
a drive signal output circuit that outputs the drive signal corresponding to the drive waveform information selected by the waveform selection circuit, and
a detection circuit that detects a state of at least one of the printhead or the head controller, and
the waveform selection circuit
selects first drive waveform information as the drive waveform information in accordance with first drive information as the drive control signal and a first waveform information table among the plurality of waveform information tables, and
selects second drive waveform information different from the first drive waveform information as the drive waveform information in accordance with the first drive information and a second waveform information table among the plurality of waveform information tables.

2. The head unit according to claim 1, wherein
the waveform selection circuit selects the drive waveform information in accordance with one of the plurality of waveform information tables selected in accordance with a detection result of the detection circuit.

3. The head unit according to claim 2, wherein
the detection circuit detects a temperature of the printhead.

4. The head unit according to claim 2, wherein
the detection circuit detects viscosity of an ink stored in the printhead.

5. The head unit according to claim 1, wherein
the waveform selection circuit selects one of the plurality of waveform information tables in accordance with a type of an ink stored in the printhead.

6. The head unit according to claim 1, wherein
the waveform selection circuit
selects third drive waveform information as the drive waveform information in accordance with second drive information as the drive control signal and the first waveform information table, and
selects the third drive waveform information as the drive waveform information in accordance with the second drive information and the second waveform information table.

7. The head unit according to claim 1, wherein
the plurality of pieces of waveform information are rewritable.

8. The head unit according to claim 7, further comprising:
a communication circuit configured to communicate with a server, wherein
at least one of the plurality of pieces of waveform information is rewritten with acquired waveform information acquired from the server via the communication circuit in accordance with a detection result of the detection circuit.

9. A liquid ejecting apparatus comprising:
a head unit including
a printhead that ejects a liquid in accordance with a drive signal, and
a head controller that receives input of a drive control signal and controls the ejection of the liquid from the printhead; and
a control unit that controls the head unit, wherein the head controller includes
a storage circuit that stores a plurality of pieces of waveform information,
a waveform selection circuit that selects one of the plurality of pieces of waveform information as drive waveform information in accordance with one of a plurality of waveform information tables and the drive control signal,
a drive signal output circuit that outputs the drive signal corresponding to the drive waveform information selected by the waveform selection circuit, and
a detection circuit that detects a state of at least one of the printhead or the head controller, and
the waveform selection circuit
selects first drive waveform information as the drive waveform information in accordance with first drive information as the drive control signal and a first waveform information table among the plurality of waveform information tables, and
selects second drive waveform information different from the first drive waveform information as the drive waveform information in accordance with the first drive information and a second waveform information table among the plurality of waveform information tables.

10. The liquid ejecting apparatus according to claim 9, wherein
the waveform selection circuit selects the drive waveform information in accordance with one of the plurality of waveform information tables selected in accordance with a detection result of the detection circuit.

11. The liquid ejecting apparatus according to claim 10, wherein
the detection circuit detects a temperature of the printhead.

12. The liquid ejecting apparatus according to claim 10, wherein
the detection circuit detects viscosity of an ink stored in the printhead.

13. The liquid ejecting apparatus according to claim 9, wherein
the waveform selection circuit selects one of the plurality of waveform information tables in accordance with a type of an ink stored in the printhead.

14. The liquid ejecting apparatus according to claim 9, wherein
the waveform selection circuit
selects third drive waveform information as the drive waveform information in accordance with second drive information as the drive control signal and the first waveform information table, and
selects the third drive waveform information as the drive waveform information in accordance with the second drive information and the second waveform information table.

15. The liquid ejecting apparatus according to claim 9, wherein
the plurality of pieces of waveform information are rewritable.

16. The liquid ejecting apparatus according to claim 15, further comprising:
a communication circuit configured to communicate with a server, wherein
at least one of the plurality of pieces of waveform information is rewritten with acquired waveform information acquired from the server via the communication circuit in accordance with a detection result of the detection circuit.

17. The liquid ejecting apparatus according to claim 10, wherein
the printhead is a line head that extends in a width direction of a medium.
